(19) United States
(12) Patent Application Publication
(10) Pub. No.: US 2026/0303925 A1
(43) Pub. Date: Oct. 1, 2026

(54) System and Method for Distributed Data Center and Power System

(71) Applicant: David E. Wachob, New Hope, PA (US)

(72) Inventor: David E. Wachob, New Hope, PA (US)

(21) Appl. No.: 19/578,278

(22) Filed: Mar. 25, 2026

Related U.S. Application Data
(60) Provisional application No. 63/778,188, filed on Mar. 26, 2025.
(60) Provisional application No. 64/003,611, filed on Mar. 12, 2026.

(51) Int. Cl. H04N 21/63; H04N 21/61

(52) U.S. Cl. CPC H04N 21/631; H04N 21/6118

(57) ABSTRACT

In one embodiment, a system includes a CATV headend, and at least one CATV node, to provide a distributed data center. The CATV headend transmits high speed data signals to and receives from the CATV node. The CATV node and the CATV headend each includes at least one high speed data switch, which receives and transmits the high speed data signals. The CATV node is also connected to one or more servers. The CATV node transmits high speed data signals to and receives from the servers. The CATV node system containing the CATV node and servers also includes a distributed power system, for powering active components on the CATV node system.

### BACKGROUND

Data centers for the processing and storage of large amounts of data are increasingly being used in a multitude of uses and industries, including artificial intelligence (AI), personal and professional data back-ups, user profile data processing and storage, analytics, complex algorithms and surveillance to name some but not all of their potential usages. They contain a very large number of computer processors, such as servers, etc. to undertake the above processing, a multi-tier structure of numerous switches and routers to transport the required data communications of the above processing, both internally and externally, as well as a multitude of large data storage devices to store the data at each stage of the above processing, such as the incoming, interim, resultant and outgoing data of such processes, etc. All of the hardware is connected with a significant amount of cabling and coordinated with complex software programs operating at very high speeds to expedite the above processes in the least amount of time possible.

The above described data centers are typically housed in a centralized location to facilitate all of the above hardware and software devices. This provides a convenient and secure common and physical structure, where hardware and software can be changed as required and managed locally in one common facility. The downsides however of such centralized data centers is that they requires substantial physical building square footage to house all the above hardware, and they also consume considerable local electrical power to operate, including back-up power to power the hardware, in the event of a power interruption or outage. Additionally, the data centers generate large amounts of localized heat that must be dissipated, as a result of not only the sheer amount of hardware present, but also the speeds at which it operates. Furthermore, by virtue of their single, centralized location, make them potentially vulnerable to catastrophic events, man-made or natural. As such, considerable debate is underway as to where these data centers are to be built, how are they going to be powered, how are they going to be properly cooled, and how vulnerable are they to catastrophic events. Thus, the need exists for an alternative to a centralized data center to overcome the above noted deficiencies.

### BRIEF SUMMARY

The present invention solves many of the key concerns described above, while still retaining the required functionality of a data center. It does so by distributing, i.e., decentralizing the data center instead of centralizing the data center, as is currently being done, as well as better distributing the power for that distributed data center. In this way, there is no need for a single large facility to house all the above noted hardware and software for the data center, nor is there the need for a single large source of power to power the data center. Decentralizing the data center also distributes the heat dissipated from the data center hardware over a greater geographic area, thereby providing more evenly distributed heat dissipation. Furthermore, decentralizing the data center hardware also allows for more efficient and cost effective localized powering and back-up, in the event of a power outage or interruption. Additionally, decentralizing the data center can also improve the data center vulnerability to catastrophic events, man-made or natural, because the data center hardware and software is not located in a single location, but rather spread across many locations.

The invention will be illustrated in conjunction with a typical cable television network, i.e., CATV network, although the invention could be implemented in other telecommunication networks such as a wired or wireless telephone and/or high speed data network, including, but not limited to, cellular networks. The invention could even be implemented over non-telecommunications networks such as an electric utility power grid network, for example. The invention leverages the distributed, decentralized nature of all these networks to provide the novel functionality described herein to address the deficiencies noted above of existing centralized data centers.

Another aspect of all the above distributed networks that helps facilitate the invention is that they all have distributed elements that are already interconnected. These interconnections are generally already present to deliver the existing services of the provider, such as CATV communication services, including high speed data services, etc. for CATV services providers. The other telecommunication providers described above are also already providing similar telecommunication services. All these telecommunication service providers generally deliver their services over these interconnections in a two-way fashion, including both downstream and upstream telecommunication signals.

In the case of CATV networks, the distributed elements are physically interconnected with a variety of coaxial cables, fiber optic cable, or even Ethernet cables, such as CAT 5 or CAT 6 cables. Some of the distributed elements also may not be physically connected, but rather be connected non-physically by wireless spectrum, such as Wi-Fi, cellular, Bluetooth, or other wireless spectrums.

Many of the same physical and non-physical connections as described for CATV networks also apply to telephone and high speed data networks, allowing these service providers to deliver their one or two way telecommunication services. In the case of electric utility power grid networks, the main connections of the distributed elements of the electric utility power grid network are the power line cables themselves, that transport the electrical power from power sources to power users.

In all of the above distributed networks including CATV networks, the existing cables could also be supplemented with additional cables (fiber optic or otherwise) or wirelessly to facilitate the invention, as well as improve the efficiency of the invention, where needed. Additional hardware may also be included as part of the above distributed networks to facilitate and improve the efficiency of the invention, as will be described.

Yet another aspect of all the above distributed networks that facilitates the invention is that the distributed elements are already provided power as well as potentially back-up power, over and/or to their existing infrastructure. This power and back-up is generally distributed and provided locally on or to the existing network as required, and can be expanded and supplemented as may be required to provide the herein described invention. In the case of the electric utility power grid network, the power is inherently already carried on the electric utility power grid network, and can easily be supplemented with additional power and/or back-up powering.

### BRIEF DESCRIPTION OF THE DRAWINGS

The present invention will become more fully understood from the detailed description and the accompanying drawings, wherein:

FIG. 1 is a block diagram of a prior art data center;

FIG. 2 is a block diagram of a prior art CATV network;

FIG. 3 is a block diagram of a prior art CATV node system;

FIG. 4 is a block diagram of an alternative CATV network, according to one embodiment, for use as a distributed data center;

FIG. 5 is a block diagram of an alternative CATV node system, according to one embodiment, for use as a distributed data center, with distributed switches and servers;

FIG. 6 is a block diagram of an alternative CATV node system, according to one embodiment, for use as a distributed data center, with server block diagram;

FIG. 7 is a block diagram of an alternative CATV node system, according to another embodiment, for use as a distributed data center, with distributed switches and servers;

FIG. 8 is a block diagram of an alternative CATV node system, according to another embodiment, for use as a distributed data center, with distributed access switch block diagram;

FIG. 9 is a block diagram of an alternative CATV network, according to another embodiment, for use as a distributed data center, with functional equivalent locations detailed;

FIG. 10 is a block diagram of an alternative CATV network, according to another embodiment, for use as another alternative distributed data center, with functional equivalent locations detailed;

FIG. 11 is a block diagram of an alternative CATV node system, according to another embodiment, that uses power extenders located throughout the CATV node system, for a distributed power system;

FIG. 12 is a block diagram of a power extender of an alternative CATV node system, according to another embodiment;

FIG. 13 is a block diagram of an AC switch within the power extender of an alternative CATV node system, according to another embodiment;

FIG. 14 is a block diagram of a charge controller within the power extender of an alternative CATV node system, according to another embodiment;

FIG. 15 is a block diagram of an inverter within the power extender of an alternative CATV node system, according to another embodiment;

FIG. 16 is a block diagram of a master controller within the power extender of an alternative CATV node system, according to another embodiment;

FIG. 17 is a block diagram of an alternative distributed power system, according to another embodiment, that uses power extenders located throughout a premise electric utility network;

FIG. 18 is a block diagram of an alternative distributed power system, according to another embodiment, that uses power extenders located throughout a premise electric utility network;

FIG. 19 is a block diagram of an alternative CATV node system, according to another embodiment, that uses power extenders located throughout the CATV node system, for a distributed power system to servers;

FIG. 20 is a block diagram of an alternative CATV node system, according to another embodiment, that uses power extenders located throughout the CATV node system, for a distributed power system to servers and switches; and

FIG. 21 is a block diagram of an alternative CATV node system, according to another embodiment, that uses power extenders integrated within servers, located throughout the CATV node system, for a distributed power system.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

In the following description, where circuits are shown and described, one of skill in the art will recognize that, for the sake of clarity, not all peripheral circuits or components are shown in the figures or described in the description. Further, the term “couple” and “operably couple” can refer to a direct or indirect coupling of two components of a circuit.

It is noted that for the sake of clarity and convenience in describing similar components or features, the same or similar reference numbers may be used herein across different embodiments or figures. This is not to imply that the components or features identified by a particular reference number must be identical across each embodiment or figure, but only to suggest that the components or features are similar in general function or identity.

Features of the present inventions may be implemented in software, hardware, firmware or combinations thereof. The computer programs described herein are not limited to any particular embodiment, and may be implemented in an operating system, application program, foreground or background processes, driver, or any combination thereof. The computer programs may be executed on a single computer or server processor or multiple server processors.

Processors described herein may be any central processing unit (CPU), microprocessor, micro-controller, computational or programmable device or circuit configured for executing computer program instructions (e.g., code). Various processors may be embodied in computer and/or server hardware of any suitable type (e.g., desktop, laptop, note-book, tablet, cellular phones, etc.) and may include all the usual ancillary components necessary to form a functional data processing device including without limitation a bus, software and data storage devices such as volatile and non-volatile memory, input/output devices, graphical user interfaces (GUIs), removable data storage, and wired and/or wireless communication interface devices including Wi-Fi, Bluetooth, LAN, etc.

Computer executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs may be referred to as a “programmable device” or “device”, and multiple programmable devices in mutual communication may be referred to as a “programmable system”. It should be noted that non-transitory “computer readable medium” or “data storage devices” as described herein may include, without limitation, any suitable volatile or non-volatile memory including random access memory (RAM) and various types thereof, read-only memory (ROM) and various types thereof, USB flash memory and magnetic or optical storage devices (e.g., internal/external hard disks, floppy discs, magnetic tape, CD-ROM, DVD-ROM, optical disks, ZIP™ drive, Blu-ray disk, and others), which may be written to and/or read by a processor operably connected to the medium.

In certain embodiments, the present inventions may be embodied in the form of computer-implemented processes and apparatuses such as processor-based data processing and communication systems or computer systems for practicing those processes. The present inventions may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

Intersecting lines in any of the FIG. below does not suggest a connection of those intersecting lines, unless specifically described in the specification.

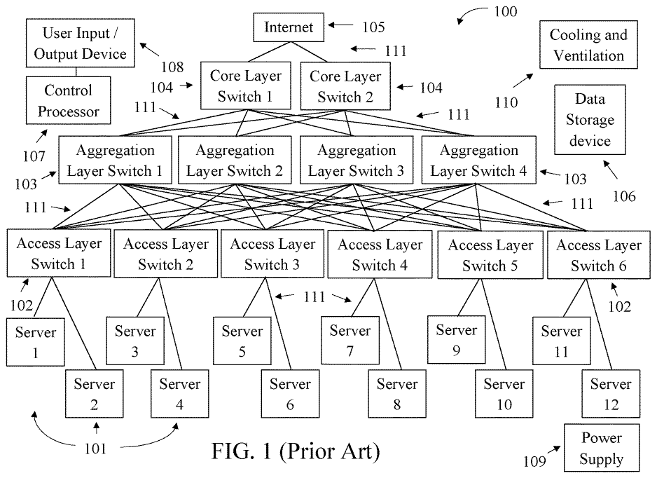

### Prior Art (FIG. 1)

FIG. 1 is a block diagram of a prior art for a centralized data center 100. Within data center 100 are several types of switches, servers, data storage, and ancillary functionality. These will each be discussed separately, starting with the servers.

The servers 101, provide the main processing functionality in the centralized data center 100. In FIG. 1, only 3 of the servers 101 are highlighted, but this is only for graphical convenience, as all 12 of the servers noted in centralized data center 100 are servers 101. The servers 101 may be identical or different than each other, only that they provide the server functionality required for centralized data center 100. It should also be noted that centralized data center 100 could contain more or less servers 101 than the 12 servers 101 noted, again, for graphical convenience only.

The servers 101 are the main processing units in the centralized data center 100. As such, they are high performance, high efficiency, state of the art computational processing units, performing complex calculations as required by the centralized data center. The servers 101 could include CPUs (central processing unit) and/or GPUs (graphics processing unit), either or both possibly including one or more core processors (not shown). The servers 101 operate at very high speeds to provide a high rate of computation within each server 101. As a result of the high speed of operation of servers 101, servers 101 consume considerable electrical power and generate considerable heat which must be dissipated from servers 101 and ultimately externally dissipated from the data center 100 into the local environment.

The servers 101 in the centralized data center 100 are in turn connected to access layer switches 102 as detailed in FIG. 1. Included in access layer switches 102 are one or more high speed Ethernet ports (not shown). As with the servers 101 described above, only 2 of the 6 access layer switches 102 are highlighted as such in FIG. 1, but again this was done only for graphical convenience. As such, all of the 6 access layer switches 102 in FIG. 1 are access layer switches 102. The access layer switches 102 may be identical or different than each other, only that they provide the access layer switching functionality required for centralized data center 100. It should also be noted that centralized data center 100 could contain more or less access layer switches 102 than the 6 access layer switches noted, again, it is noted as such for graphical convenience only. Additionally, while each access layer switch 102 is shown in FIG. 1 as being connected to only 2 servers 101, this was again done only for graphical convenience, and each access layer switch 102 could be connected to more or less than 2 servers 101.

The access layer switch 102 sends two-way high speed switched data of the centralized data center 100 to and from each of the servers 101. Control of this two-way high speed switched data of the distributed data center, and specifically to which server 101 this two-way high speed switched data is sent to and received from at any given time, is determined by the control processor 107 and access layer switch 102. Control of this data traffic of the centralized data center is determined by many factors, including but not limited to, the type of data, the priority of that data and the specific loading (utilization) of either the access layer switch 102 or any of the servers 101, etc.

One of the main (but not only) purposes of the access layer switches 102 is to control the data traffic going to and from the servers 101 to best support of the required calculations that need to be performed by the servers 101 in the centralized data center 100. Some of the servers 101 in the centralized data center 100 may be specialized, dedicated, or prioritized for specific types of calculations or even specific customers or types of customers that utilize the services provided by the centralized data center 100.

Some of the servers 101 in the centralized data center 100 may also not be being fully utilized at any particular instant in time when compared to other servers 101. As such, load balancing functionality (not shown) can be performed by the access layer switches 102, so that the required calculations that need to be performed by the servers 101 in the centralized data center 100 are better performed and more equally balanced between all the servers 101, thereby improving the efficiency of the centralized data center 100. This load balancing can be dynamically changed on an as required basis, increasing the efficiency of the data processing within the centralized data center 100, and can also be utilized if one or more of the servers 101 need to be taken off-line as a result of server 101 failure, replacement, upgrade or scheduled maintenance.

Directly above and connected to the access layer switches 102 in FIG. 1 are the aggregation layer switches 103. Included in aggregation layer switches 103 are one or more high speed Ethernet ports (not shown). As illustrated in FIG. 1, the aggregation layer switches 103 connect to each of the access layer switches 102. As with the servers 101 and access layer switches 102 described above, not all of the aggregation layer switches 103 are numbered accordingly, but this was again done only for graphical convenience. Likewise, the aggregation layer switches 103 may be identical or different than each other, and there may be more or less than four aggregation servers 103, only that they provide the aggregation layer switching functionality required for centralized data center 100. Additionally, while each aggregation layer switch 103 is shown in FIG. 1 as being connected to 6 access layer switches 102, this was again done only for graphical convenience, and each aggregation layer switch 103 could be connected to more or less than 6 access layer switches 102.

The aggregation layer switch 103 sends two-way high speed switched data of the centralized data center 100 to and from each of the access layer switches 102. Control of this two-way high speed switched data of the centralized data center 100, and specifically to which access layer switch 102 this two-way high speed switched data is sent to and received from at any given time, is determined by control processor 107 and aggregation layer switch 103. Control of this data traffic of the centralized data center is determined by many factors, including but not limited to, the type of data, the priority of that data and the specific loading (utilization) of either the aggregation layer switch 103 or any of the access layer switches 102, etc.

One of the main (but not only) purposes of aggregation layer switches 103 is to control the data traffic going to and from the access layer switches 102 to best support the required calculations that need to be performed by the servers 101 in the centralized data center 100.

Some of the access layer switches 102 in the centralized data center 100 may also not be being fully utilized at any particular instant in time when compared to other access layer switches 102. As such, load balancing functionality (not shown) may also be performed by the aggregation layer switches 103, so that the required switching of data that needs to be switched to and from the access layer switches 102 in the centralized data center 100 is better performed and more equally balanced between all the access layer switches 102, thereby improving the efficiency of the centralized data center 100. This load balancing can be dynamically changed on an as required basis, to maximize the efficiency of the access layer data switching within the centralized data center 100, and can also be utilized if one or more of the access layer switches 102 need to be taken off-line as a result of access layer switch 102 failure, replacement, upgrade or scheduled maintenance.

Directly above and connected to the aggregation layer switches in FIG. 1 are the core layer switches 104. Included in core layer switches 104 are one or more high speed Ethernet ports (not shown). As illustrated in FIG. 1, the core layer switches 104 connect to each of the aggregation layer switches 103. As with the servers 101, access layer switches 102, and aggregation layer switches 103, there may be more or less than the 2 core layer switches 104 so indicated, as this was done only for graphical convenience. Likewise, the core layer switches 104 may be identical or different than each other, only that they provide the core layer switching functionality required for centralized data center 100. Additionally, while each core layer switch 104 is shown in FIG. 1 as being connected to only 4 aggregation layer switches 103, this was again done only for graphical convenience, and each core layer switch 104 could be connected to more or less than 4 aggregation layer switches 103.

The core layer layer switch 104 sends two-way high speed switched data of the centralized data center 100 to and from each of the aggregation layer switches 103. Control of this two-way high speed switched data of the centralized data center 100, and specifically to which aggregation layer switch 103 this two-way high speed switched data is sent to and received from at any given time, is determined by control processor 107 and core layer layer switch 104. Control of this data traffic of the centralized data center is determined by many factors, including but not limited to, the type of data, the priority of that data and the specific loading (utilization) of either the core layer switch 104 or any of the aggregation layer switches 103, etc.

One of the main (but not only) purposes of core layer switches 104 is to control the data traffic going to and from the aggregation layer switches 103 to best support the required calculations that need to be performed by the servers 101 in the centralized data center 100. Some of the aggregation layer switches 103 in the centralized data center 100 may also not be being fully utilized at any particular instant in time when compared to other aggregation layer switches 103. As such, load balancing functionality (not shown) may also be performed by the core layer switches 104, so that the required switching of data that needs to be switched by the aggregation layer switches 103 in the centralized data center 100 is better performed and more equally balanced between all the aggregation layer switches 103, thereby improving the efficiency of the centralized data center 100. This load balancing can be dynamically changed on an as required basis, to maximize the efficiency of the aggregation layer data switching within the centralized data center 100, and can also be utilized if one or more of the aggregation layer switches 103 need to be taken off-line as a result of access layer switch 103 failure, replacement, upgrade or scheduled maintenance.

The core layer switches 104 are connected to the Internet 105 or other WAN (wide area networks) locations (not shown), internal or external to the centralized data center 100 and as such, the core layer switches coordinate the communications of data to and from the centralized data center 100. To facilitate this data communications, one or more routers or routing functionality (not shown) is also contained within the core layer switches 104 and/or separate from the core layer switches 104. This routing functionality provides the correct address (IP or otherwise) as to where the data from the core layer switches 104 is to be sent to or received from on the Internet 105 or other locations. The core layer switches 104 also provide for firewall functionality (not shown), either internal to or external from the core layer switches 104, which protects against unauthorized access into or out of the centralized data center 100.

Data storage device 106 provides for data storage of the centralized data center 100 for a variety of data, including (but not limited to) incoming, interim and outgoing data processed by the centralized data center 100. The data storage device 106 functionality could be provided by one or more physical data storage devices 106, as well as virtually (not shown) within one or more of these physical data storage devices 106, although only 1 such data storage device 106 is illustrated for graphical convenience. These data storage devices 106 would primarily be located within the centralized data center 100, although they could also be located remotely from the centralized data center 100, in the cloud or otherwise (not shown). Since securing the existence and integrity of the data from the data storage devices 106 is fundamental to the functionality of the centralized data center 100, one or more methods of providing redundancy or disaster recovery for such data is provided by the centralized data center 100 (not shown).

The control processor 107 in FIG. 1 controls and coordinates all of the above processes from one (or more) processors in the centralized data center 100, under computer program control. It interfaces with the one or more user input/output device 108, from which user commands are inputted to and outputs received from, the control processor 107 through a variety of means, including GUIs, print outs, data files, etc. The GUI or other means within the user input/output device 108 also provide for other functionality, including but not limited to, monitoring, troubleshooting, server and switch performance, loading and load balancing, energy utilization and control, temperature readings from any location within or external to via temperature sensors (not shown), customer authentication and billing, etc. of the centralized data center 100. Any or all of these user input and output devices 108 could also be enacted virtually, from within or outside of the centralized data center 100, not shown.

Cooling and ventilation in FIG. 1 is provided by the functionality within cooling and ventilation 110. This functionality could be provided by numerous methods, including one or more air conditioning units, fans, heat pumps, circulating water or other liquids or gases, etc. (not shown) to dissipate the heat generated from the centralized data center 100. As mentioned previously, considerable heat is generated by the centralized data center 100, so dissipation of this heat generated is critical to the operation of the centralized data center 100, so more than one cooling and ventilation systems 108 could be employed, including back-up systems in the event of a failure of one or more of those systems, not shown. Some or all of the cooling and ventilation 110 may be internal to, or external from, the centralized data center 100.

Power supply 109 in FIG. 1 provides powering for the active components of centralized data center 100. Even though only one power supply 109 is indicated, there could be one or more power supply 109, and these one or more power supply 109 could also include one or more back-up power supplies (not shown) due to the critical nature of providing power to the centralized data center 101. The power connections between the power supply 109 and all these active components in FIG. 1, including cooling and ventilation 109, is implied but not indicated, for graphical simplicity.

The connections 111 between all the servers 101, access layer switches 102, aggregation layer switches 103, core layer switches 104 are generally although not exclusively, two-way high speed data connections, generally by fiber optic or Ethernet cables, while the connection 111 to and from the Internet 105 from and to the core layer switch 104 which would almost exclusively be a fiber optic cable. If a fiber optic cable is used for any of the connections 111, at each end of the fiber optic cable would be a transceiver (not shown) that would first convert the data signals from or to an Ethernet or other non-optical data signals to an optical signal on one or more wavelengths. The optical signals would then be transported over the fiber optic cables, and then reconverted back to or from an Ethernet or other non-optical signal at the other end of the fiber optic cable. These connections support very high speed data rates, generally, although not exclusively, from single Gbps (gigabits per second) to 100's of Gbps.

Most all the connection 111 illustrated in FIG. 1 below the core layer switches are considered part to the centralized data center 101 LAN (local area network) including Internet 105, and as such, are generally addressed by the respective MAC (media access control) of the specific hardware illustrated in FIG. 1. Most all the connections 111 above the core layer switches 104 are considered part of one or more WAN (wide area network) outside of the centralized data center 101. As such, these WAN connections are generally, although not exclusively, addressed by their IP (Internet Protocol) address.

Connections into and out of the data storage devices 106 are also implied but not indicated, for graphical simplicity. These data storage devices 106 may be part of the above described LAN including the connection methods described for the LAN, and/or these data storage devices 106 may also be included within any of the servers 101, access layer switches 102, aggregation layer switches 103, core layer switches 104 or control processor 107 within the centralized data center 101. Additionally, some of these data storage devices 106 may be external to the centralized data center 100 as described previously for data back-up or disaster recover purposes, etc., by one or more WAN networks, not shown.

The control processors 107 and input/output user devices 108 are generally although not exclusively, also connected to the LAN described above by the same or similar means. Alternatively, one or more of the control processors 107 could be located external to the centralized data center 100, and connected by one or more WAN networks or other networks, not shown.

Cooling and ventilation 110 and power supply 109 may also connected to the WAN of the centralized data center 100 (not shown), for control and monitoring purposes.

FIG. 1 is also not meant to include all of the particular items in a centralized data system 100, only those items that are most relevant to the proposed embodiments of the invention.

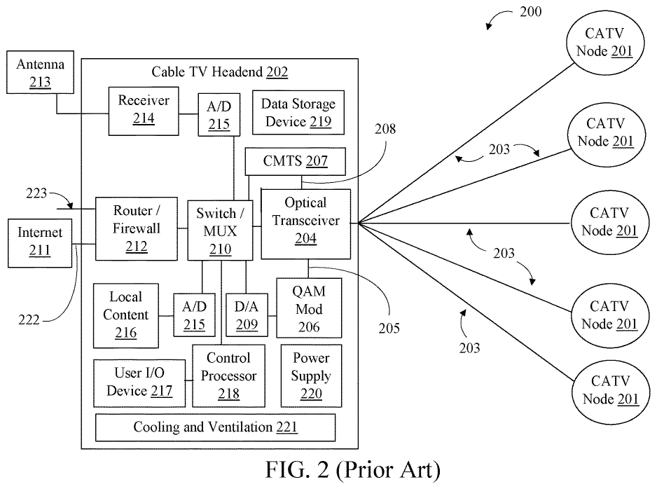

### Prior Art (FIG. 2)

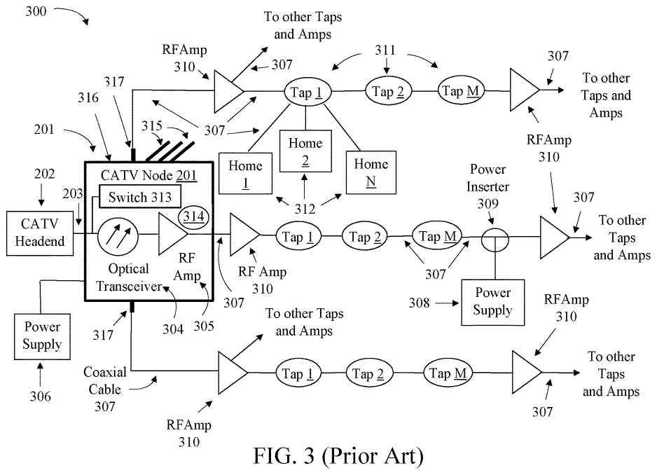

FIG. 2 is a high level block diagram of a prior art CATV network 200, and the primary components. Within FIG. 2 are CATV nodes 201, the CATV headend 202 and two-way fiber optic cables 203 that connect the CATV nodes 201 to the CATV headend 202, as well as interfaces to the Internet 211 and/or other networks via two-way fiber optic cables 222 and fiber optic cables 223, respectively. Only one CATV headend 202 is indicated in FIG. 2 for simplicity, but large CATV networks 200 could have more than one CATV headend 202, not shown. Similarly, even though FIG. 2 shows 5 CATV nodes 201 connected to the CATV headend 202, it is for graphical purposes only, and any given CATV headend 202 could be connected to more or less than 5 CATV nodes 201. The number of CATV nodes 201 in any given CATV network 200 is generally determined by the number of homes or businesses served by the CATV node 201, which generally although not exclusively, is between 125 and 500 homes or businesses served by any given CATV node 201. Details on how these homes or businesses are connected to the CATV node 201 will be detailed in FIG. 3.

Within CATV headend 202, the primary functional blocks are detailed in FIG. 2. Optical transceiver 204 connects the above mentioned CATV nodes 201 with one or more modulators, generally although not exclusively, QAM (quadrature amplitude modulated) mod (modulator) 206 in the CATV headend 202 for processing the CATV program signals 205. Optical transceiver 204 also connects the above mentioned CATV nodes 201 with one or more CMTS (cable modem termination servers) 207 in the CATV headend 202 for processing the two-way CATV modem signals 208. These CATV program signals 205 and the CATV modem signals 208 are then converted to two way optical signals in the optical transceiver 204 for transport over the fiber optic cables 203 from the CATV headend 202 to and from each CATV node 201. The CATV program signals 205 and CATV modem signals 208 consist of CATV content (TV program channels, movies, music, etc.) and high speed data (Internet/WiFi data, VoIP telephony, etc., and are usually although not necessarily, transported in the form of DOCSIS, or Data Over Cable Services Interface Specification) signals.

D/A (digital to analog converter) 209 may or may not be required, depending on the type of input required for the QAM Mod 206. If the input signal into the QAM Mod 206 for CATV program signals 205 is required to be in an analog format, D/A 209 will be required to first convert the digital signals from the output of the Switch/MUX (multiplexer) 210 into an analog format. If the input signal into the QAM mod 206 CATV signals are required to be in a digital format, D/A 209 may not be required to first convert the digital signals from the output of the Switch/MUX (multiplexer) 210 into an analog format. Instead, the digital signals from the output of the Switch/MUX (multiplexer) 210 may be inputted directly into the QAM mod 206.

Switch/MUX 210 interfaces with the CMTS 207 to provide both downstream and upstream high speed data from and to the Internet 211 over fiber optic cable 222 via router/firewall 212 to the CMTS 207. The connection to the Internet 211 and the connections to the router/firewall 212 and CMTS 207 support two-way high speed switched data connections, generally, although not exclusively, via fiber optic or Ethernet cables. Connectivity between the router/firewall 212 and the Internet 211 is generally provided by a fiber optic cable 222. Alternatively or in addition to, fiber optic cable 223 could provide high speed data access to or from the CATV headend 202 to other CATV headends 202, etc. via alternative WANs, not shown.

Antenna 213 and receiver 214 allow for over the air (satellite and/or terrestrial, etc.) program content to be delivered over the CATV network 200. Even though only one such antenna 213 and receiver 214 are indicated in FIG. 2, there could be more than one of each antenna 213 and receiver 214 connected to the CATV headend 202 (or at a distance remote from CATV headend 202). A/D (analog to digital converter) 215 may or may not be required, depending on the output signal from the receiver 214 to the input of the switch/MUX 210. If receiver 214 outputs an analog signal, then A/D 215 will be required. If receiver 214 outputs a digital signal, then A/D 215 may not be required.

Local content 216 (i.e., onsite program content, etc.) can also be delivered over the CATV network 200. Such local content 216 could include local programming, advertising, etc., and could be in either digital or in analog format, for delivery on the CATV network 200. If the local content 216 is in an analog format, then A/D 215 will be required to first convert the local content 216 to a digital format, before being sent to the Switch/MUX 210. If the local content 216 is in a digital format, then A/D 215 may not be required to first convert the local content 216 to a digital format, before being sent to the Switch/MUX 210.

Switch/MUX 210 interfaces with the Internet 211 via router/firewall 212 to the Internet 211 via fiber optic cable 222 to allow the CATV headend 202 to provide streaming program content to the CATV nodes 201. Switch/MUX 210 also interfaces with the receiver 214, potentially through A/D 215, to allow the CATV headend 202 to provide over the air program content from antenna 213 to the CATV nodes 201. Switch/MUX 210 also interfaces with local content 216, potentially through A/D 215, to allow the CATV headend 202 to provide local content 216 to the CATV node 201. Switch/MUX 210 also interfaces with optical transceiver 204, to allow the CATV network 200 to provide additional high speed data connections to the CATV nodes 201. As such, switch/MUX 210 multiplexes the streaming program content, over the air program content, local content, high speed Internet data and additional high speed data connections for delivery from the CATV headend 202 to the CATV nodes 201 over the CATV network 200.

FIG. 2 also shows functional blocks for the user I/O (input and output) device 217 and control processor 218. The control processor 218 in FIG. 2 controls and coordinates all of the above processes from one (or more) processors in the CATV network 200, under computer program control. It interfaces with the one or more user I/O device 217, from which user commands are inputted to and results outputted from, the control processor 218 through a variety of means, including GUIs, files or other means. The GUI and control processor 218 or other means within the user I/O device 217 also provide for other functionality, including but not limited to, monitoring, troubleshooting, channel assignment, customer authentication and billing, switch loading and control, security, data encryption/decryption, energy utilization and control, and heat generation, etc. from the control processor 218 and of the CATV system 200. Any or all of the user I/O device 217 could also be accessed virtually, from within or outside of the CATV headend 202, not shown.

Data storage device 219 stores any data relevant to the CATV network 200, including but not limited to, monitoring, troubleshooting, channel assignment, customer authentication and billing, switch loading and control, security, energy utilization, and heat generation, etc. While data storage device 219 is not shown as physically connected to any of the other devices in the CATV headend 202, this is only done for graphical convenience, and data storage device 219 is generally connected to the LAN which connects most all the devices in the CATV headend 202. The data storage device 219 functionality could be provided by one or more physical data storage devices 219, as well as virtually (not shown) within one or more of these physical data storage devices 219, although only 1 such data storage device 219 is illustrated for graphical convenience. Additionally, these data storage devices 219 may be external to the CATV headend 202 for data back-up or disaster recover purposes, etc. (not shown).

Power supply 220 in FIG. 2 provides powering for the active components of the CATV headend 202. Even though only one power supply 220 is indicated, there could be one or more power supply 220, and these one or more power supply 220 could also include one or more back-up power supplies (not shown) due to the critical nature of providing power to the CATV headend 202. The power connections between the power supply 220 and all these active components in the CATV headend 202 are implied but not indicated, for graphical simplicity. The power supply 220 could also be connected to the LAN of the CATV headend 202 (not indicated) for status monitoring and control of power supply 220.

CATV headend 202 in FIG. 2 also includes cooling and ventilation 221, which dissipates any heat generated by any of the above components within the CATV headend 202. Cooling and ventilation 221 could include conventional and non-conventional cooling and ventilation methods. Conventional methods could include HVAC (heating, ventilation and cooling) units, etc., while unconventional methods could include geothermal units, as but just one example of each method. While cooling and ventilation 221 is shown as internal to the CATV headend 202, parts of cooling and ventilation may be external to the CATV headend 202, such the compressors, condenser, fans, etc. (not shown).

Connections between the switch/MUX 210 and the router/firewall 212, CMTS 207, optical transceiver 204, control processor 218, A/D 215 and D/A 209 are generally although not exclusively over the internal LAN using one or more high speed Ethernet ports (not shown). The LAN is also connected to the data storage device 219 as mentioned, and can also connect to the cooling and ventilation 221 and receiver 214 for status monitoring and control, not shown.

While the implementation of the functionality within CATV network 200 is highlighted in FIG. 2 including but not limited to the CATV headend 202, it is not meant to illustrate the only way to implement the functionality within CATV network 200. As such, some of the functionality represented in FIG. 2 may be implemented in other ways or at other locations within CATV system 200, or some of the functionality represented in FIG. 2 may not be implemented at all within CATV network 200. FIG. 2 is also not meant to include all of the particular items in a CATV network 200, only those items that are most relevant to the proposed embodiments of the invention.

### Prior Art (FIG. 3)

FIG. 3 is a block diagram of a prior art CATV node system 300, and all the primary components. Within FIG. 3 is the one of the CATV node 201 from FIG. 2, from where signals are received from and sent to the CATV headend 202 and are distributed to the CATV subscribers served by that particular CATV node 201. The CATV signals, consisting of CATV content (TV program channels, movies, music, etc.) and high speed data (Internet/WiFi data, VoIP telephony, etc., usually although not necessarily, are generally transported in the form of DOCSIS, or Data Over Cable Services Interface Specification) signals. From the CATV headend 202, the CATV signals are transported over two-way fiber optic cable 203 to the CATV node 201, consisting of an optical transceiver 304 and an RF amp 305, which converts the optical CATV signals to CATV RF signals, generally (although not exclusively) from 5 Mhz to 1.8 Ghz, which are then transported on coaxial cable 307 from the CATV node 201. Even though there are three outputs shown as coming out of the CATV node 201 in FIG. 3 on coaxial cables 307, only two such outputs are marked as node output 317. There could be one or more node outputs 317 from one or more RF amp 305 inside of CATV node 210, not shown.

These CATV signals (both optical and RF) are two-way CATV signals, consisting of both downstream signals and upstream signals. The downstream RF channels are generally (although not exclusively) from 108 Mhz to 1.8 Ghz and consist of the CATV signals going to the homes 312 (and/or businesses, not shown) served by the CATV Node 201. The upstream RF channels are generally (although not exclusively) from 5 Mhz to 85 Mhz and consists of the CATV signals coming from the home or business 312 to the CATV node 201.

Also indicated in FIG. 3 is power supply 306, for powering the active devices on a CATV node system 300, which include the CATV node 201 itself, as well as the various amplifiers, WiFi access points, (not shown) etc., present in the CATV node system 300. While power supply 306 is shown external to the CATV node 201, it could also internal to the CATV node 201, in whole or in part. This power supply 306 connects to the electric utility power grid (not shown), and converts that power (generally, 110 VAC) and injects the converted power signal into the CATV node system 300, typically, although not exclusively, as 60 Hz AC power from 60 VAC to 90 VAC (volts AC). This power is typically transported on the center conductor of the coaxial cables 307 to or through all the components in the CATV node system 300. The power supply 306 on the left of FIG. 3 injects the power directly into the CATV node 201, where the power, in addition to powering CATV node 201, is in turn fed to other components in the CATV node system 300 via the center conductor of the coaxial cables 307 at node output 317 as described above. The power supply 308 on the right side of FIG. 3 could be similar or different to power supply 306 on the left in FIG. 3, or it could instead be power provided from another node output 317 of the CATV node system 300 that has excess power. In either case, the power is generally inserted into the CATV node system 300 through a power inserter 309 as indicated, which as before, inserts the power onto the center conductor of coaxial cable 307 of the CATV node system 300. Alternatively, power could also be fed directly to one or more RF amps 310 from a similar or different power supply 306 or power supply 308 on the CATV node system 300. Any power supply 306 or power supply 308 on the CATV node system 300 could also include a redundant (back-up) power supply to improve the reliability of the power on the CATV node system 300, not shown.

Accordingly, the coaxial cables 307 in FIG. 3 transport both the CATV RF signals and the power signal in the CATV node system 300, with one exception. That exception is the coaxial cables 307 connecting the homes (or businesses) 312 to the taps 311, which generally only transport the CATV RF signals to the homes (or businesses) 312.

In addition to powering the active devices such as RF amps 310, etc. on the CATV node system 300, the power signal must pass through passive (non-powered) devices on the CATV node system 300, such as the taps 311 as indicated on FIG. 3. These taps 311 in FIG. 3 allow for both the power and CATV RF signals to be passed through them for other devices in the CATV node system 300 (with the exception noted above to homes (or businesses) 312). When the budgeted power for the specified active components on the CATV node system 300 has been consumed, an additional power supply 308 and/or power inserter 309 must be added in that section of the coaxial cable 307 of the CATV node system 300 requiring power.

The CATV node 201 may also likely include a switch 313 which is also connected to fiber optic cable 203 from the CATV headend 202. The communication signals between switch 313 and the CATV headend 202 may be on the same or another fiber optic cable 203, and if the former, could be on another optical wavelength on fiber optic cable 203, and can provide additional high speed data connections for consumer or commercial use between the CATV headend 202 and the CATV node 201, for current or future use.

While a conventional CATV Node 201 is indicated in FIG. 3, it is not meant to be exhaustive. The proposed invention works equally well with more advanced CATV nodes, such as Remote Phy (physical layer) nodes (i.e., RPHY nodes) and/or Remote MAC Physical nodes (i.e., R MAC PHY nodes). Both the RPHY nodes and R MAC PHY nodes are more advanced versions of conventional CATV node 201, in that they may move some of the hardware and/or processing software from the CATV headend 202 out to the CATV node 201, not shown. Movement of this hardware and/or processing software from the CATV headend 202 out to the CATV node 201 can be facilitated with the switch 313 in FIG. 3. Switch 313 may or may not have Ethernet connections, not shown.

FIG. 3 also includes data storage device 314 that stores data relevant to the operation of the CATV node system 300. This data could include but is not limited to, data that is specific to customers served by the CATV node system 300, the identification, configuration, performance and/or troubleshooting of components contained within the CATV node system 300, and security and outages on the CATV node system 300, etc.

FIG. 3 highlights the CATV node housing 316 surrounding the CATV node 201. The CATV node housing 316 is generally although not exclusively, made out of metal or other materials that efficiently transfer any heat generated from the components of the CATV node 201 such that the heat generated can be dissipated into the air around the CATV node housing 316.

FIG. 3 also includes cooling fins 315 on the CATV node housing 316, that help dissipate any of the heat generated internally by the components within the CATV node 201. Even though three such cooling fins 315 are indicated in FIG. 3, there could be more or less than 3 cooling fins 315, generally located on and/or around the CATV node housing 316. The cooling fins 315 are generally partially or even fully located around the entire CATV node housing 316.

Cooling fins 315 are generally although not exclusively, made out of metal or other materials, generally attached to, or an integral part of, the CATV node housing 316, such that the any heat generated internally by the components of the CATV node 201 can be more efficiently dissipated into the air around the CATV node housing 316 and cooling fins 315.

As indicated in FIG. 3 and the details above, from the node outputs 317 of CATV node 201, the CATV RF signals (two-way) and power signals are transported over coaxial cable 307 to RF amps 310, taps 311, and ultimately to homes 312 (and/or businesses, not shown) on the CATV node system 300. Although only a single node 201 is indicated in FIG. 3, in any given CATV network 200, there could be one or more CATV nodes 201 (as detailed previously in FIG. 2), each of which will in turn be connected to one or more RF amp 310 from one or more node outputs 317 (although potentially there could be no RF amp 310) each of which will in turn be connected to one or more taps 311. Each tap 311 services typically between 1 and N homes (or businesses) where N is generally between 1 and 8, and from any given RF amp 310, there would be a number of M taps 311, where M is typically between 4-6 taps 311 typical until the next RF amp 310 or last home 312 served by the RF amp 310. The taps 311 may also be located before the first RF Amp 310 out of each node output 317, not shown.

The CATV nodes 201, the RF amps 310, the taps 311, the coaxial cables 307 and fiber optic cables 203 are generally although not exclusively, installed on and supported by, telephone poles and strand wire between those telephone poles (neither shown) in the CATV network 200, including CATV node system 300. The power supplies 306, power supply 308 and power inserter 309 might also be installed on and supported by, telephone poles and strand wire between those telephone poles (neither shown) in the CATV network 200, including CATV node system 300.

FIG. 3 and the descriptions above are also not meant to include all of the particular items in a CATV node system 300, only those items that are most relevant to the proposed embodiments of the invention.

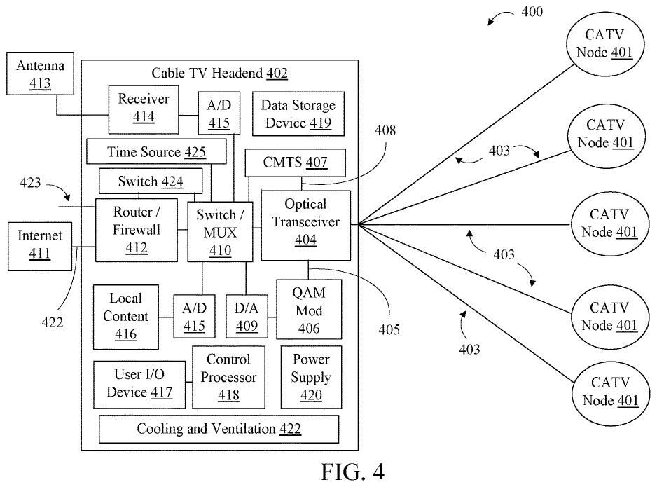

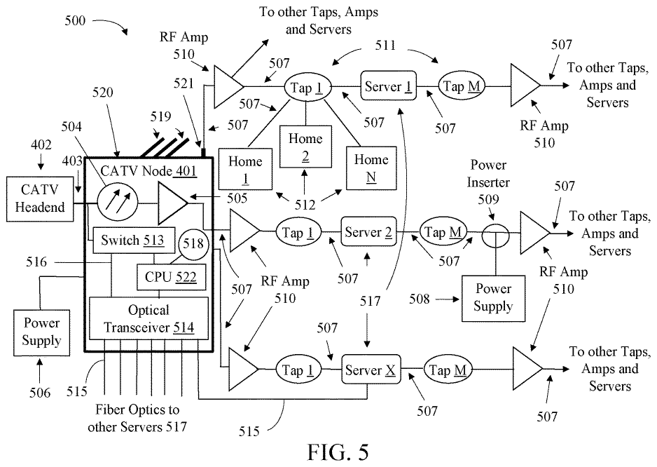

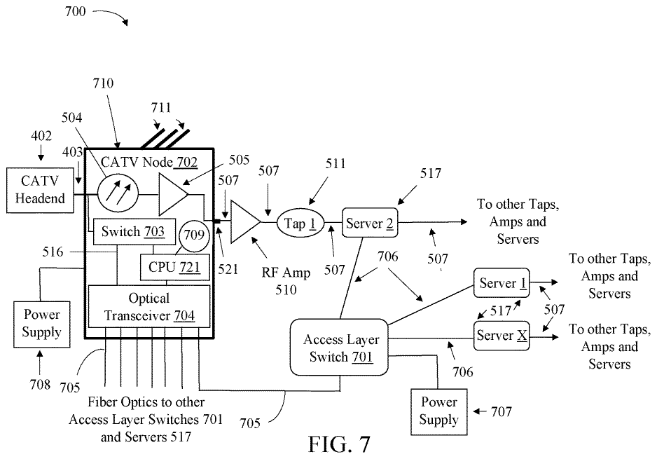

FIG. 4 is a block diagram of an alternative CATV network 200, according to one embodiment, for use as a distributed data center 400. The invention leverages the CATV network 200 to decentralize the data center functionality described in FIG. 1. In the CATV headend 402 in FIG. 4, switch 424 has been added, which can be an aggregation layer switch or a core layer switch, with the same or similar functionality of the aggregation layer switch 103 in FIG. 1 or the core layer switch 104 in FIG. 1. Whether switch 424 will be an aggregation layer switch or a core layer switch will be detailed later in details regarding FIG. 5 and FIG. 7. Switch 424 can include one or more high speed Ethernet ports (not shown). The switch 424 connects to either an access layer switch or an aggregation layer switch that are now part of the CATV node 401 or CATV node 702, respectively that will be described and clarified more fully in FIG. 5. and FIG. 7, respectively. As such, switch 424 sends two-way high speed switched data of the distributed data center 400 to, and receives high speed data from, one or more CATV nodes 401 or CATV nodes 702. Contained within one or more CATV nodes 401 or CATV nodes 702 are either one or more access layer switch or one or more aggregation layer switch that are now part of the CATV node 401 or CATV node 702, respectively.

The switch 424 is connected to the router/firewall 412 which provides firewall protection to protect against unauthorized access into or out of this part of the distributed data center 400. The router/firewall 412 also provides routing functionality to provide the correct address (IP or otherwise) as to where the data from the switch 424 is to be sent to or received from on the Internet 411 via fiber optic cable 422 or other WANs via fiber optic cable 423.

If there are more than one CATV headend 402 in a distributed data center 400, then there could be more than one or more switches 424 as so indicated. These additional CATV headend 402 in the distributed data center 400 could be connected to each via fiber optic cable 422 to the Internet 411, and/or they could be connected to fiber optic cable 423, which could be connected to one or more additional CATV headend 402 (not shown). Fiber optic cable 423 connected to one or more additional CATV headend 402 may or may not already be present in the distributed data center 400, to provide back up to the Internet 411 or other CATV headends 402. Switches 424 in additional CATV headends 402 may be identical or different than each other, only that they provide the switching functionality required for the distributed data center 400.

The switch 424 in FIG. 4 is also connected to downstream (to the right) of the CATV headend 402 to CATV nodes 401 (or CATV node 702, to be detailed later) via switch/MUX 410 and optical transceiver 404 to the CATV nodes 401 (or CATV node 702) via one or more fiber optic cables 403. These connections are the primary two-way data connections between the switch 424 and the CATV nodes 401 (or CATV nodes 702). Additionally, while the switch 424 is shown in FIG. 4 as being connected to only 5 CATV nodes 401 via switch/MUX 410, optical transceiver 404 and fiber optic cables 403, this was again done only for graphical convenience, and each switch 424 could be connected as such to more or less than 5 CATV nodes 401 (or CATV node 702) in the distributed data center 400.

Switch 424 and control processor 418 control the two-way high speed switched data of the distributed data center 100 from the CATV headend 402, to and from each one or more CATV nodes 401 or CATV nodes 702. Contained within one or more CATV nodes 401 or CATV nodes 702 are either one or more access layer switch or one or more aggregation layer switch that are now part of the CATV node 401 or CATV node 702, respectively. Control of this high speed switched data, and specifically to which CATV node 401 or CATV node 702 this high speed data is sent to and received from at any given time, is determined by switch 424 and control processor 418. Control of this two-way high speed switched data of the distributed data center 100 is determined by many factors, including but not limited to, the type of data, the priority of that data, and the specific loading (utilization) of any of the above mentioned switches or specific ports on any of the above mentioned switches, processing resources available in the servers 517, etc., at any given time.

Switch 424 and control processor 418 also perform the function of load balancing of the two-way high speed switched data of the distributed data center 100, between the switch 424 and each of the either the access layer switch 513 in node 401 or the aggregation layer switch 703 in node 702 (distinction to be described below). This load balancing helps to ensure that all the required switching to either the access layer switches 513 in node 401 or the aggregation layer switches 703 in node 702 in the CATV node system 500 or CATV node system 700, respectively, is more efficiently performed and more equally balanced between all the access layer switches 513 in nodes 401 or the aggregation layer switches 703 in nodes 702 in the CATV node systems 500 or CATV node systems 700, respectively. This load balancing can be dynamically changed on an as required basis, and also can also be utilized if one or more of the access layer switches 513 in node 401 or the aggregation layer switches 703 in node 702 need to be taken off-line as a result of server failure, replacement, upgrade or scheduled maintenance.

The switch 424, optical transceiver 404, control processor 418 or similar means within CATV headend 402 can support encryption and decryption of the data signals going to and coming from CATV nodes 401 and/or CATV nodes 702 coming from or going to CATV headend 402, respectively, for security purposes, using any number of industry encryption techniques (not shown).

Time source 425 is included in FIG. 4, to provide a precise time reference signal for the two-way high speed switched data communications between the CATV headend 402 and nodes 401, as well as nodes 702, to be detailed in FIG. 5 and FIG. 7, and other items connected to those nodes 401 and nodes 702, also to be detailed in FIG. 5 and FIG. 7. The time source 425 could be derived from a high precision clock atomic clock, cesium or otherwise or any other precision source, such as a GPS or WiFi signal, or otherwise. The precise time reference signal generated from time source 425 is communicated from the CATV headend 402 to the CATV nodes 401, as well as to nodes 702 to be detailed in FIG. 5 and FIG. 7, and other items connected to those node 401 and nodes 702, also to be detailed in FIG. 5 and FIG. 7. The time reference signal from time source 425 is also stored in data storage device 419, data storage device 518, data storage device 709, data storage device 608 and data storage device 717.

FIG. 4 also shows functional blocks for the user I/O (input and output) device 417 and control processor 418. The control processor 418 in FIG. 4 controls and coordinates all of the processes from one (or more) control processors 418 in the distributed data center 400, (and the CATV node system 500 and CATV node system 700, to be described later) under computer program and user control. The control processor 418 interfaces with the one or more user I/O device 417, from which user commands are inputted to and results outputted from, the control processor 418 through a variety of means, including GUIs or other means. The control processor 418 and the I/O device 417 also facilitate and coordinate the input and output of client (customer) data into and out of the distributed data center 400. The control processor 418 provides for the functionality and control of, including but not limited to, monitoring, troubleshooting, channel assignment, customer authentication and billing, switch loading and control, energy utilization and control, and heat generation, security, encryption/decryption, etc. of the distributed data center 400. Coordination of data timing, synchronization, and decryption/encryption between the CATV headend 402 and CATV node systems 500 and CATV node systems 700 are also provided by the control processors 418. The encryption and decryption of the signals going to and coming from the CATV headend 402, for security purposes, can be provided using any number of industry encryption techniques (not shown).

Any or all of the user I/O devices 417 and/or control processor 418 may also be accessed virtually, from within or outside of the CATV headend 402, not shown, with appropriate data security measures put in place, not shown.

Connectivity to and from the Internet 411 in FIG. 4 may need to be enhanced or increased from what it was when compared to the Internet 211 in FIG. 2, to support the addition of the switch 424 in the CATV headend 402. Likewise, the optical transceiver 404 and connectivity to and from it and the CATV headend 402 and the CATV node 401 (or CATV node 702) via fiber optic cables 403 in FIG. 4 may need to be enhanced or increased from what it was when compared to the optical transceiver 204 in FIG. 2 to support the addition of the switch 424 in the CATV headend 402. Both the above described enhancements or increases could be provided with additional fiber optic cables to and from the Internet 411 via fiber optic cable 422 and CATV headend 402, and/or to and from the CATV headend 402 and the CATV nodes 401 (or CATV nodes 702) via fiber optic cables 403. Alternatively or in addition to, the above described enhancements or increases could also be provided by using additional optical wavelengths and/or different optical modulations on any of the above referenced fiber optic cables. As such, these connectivity enhancements or increases could be in the form of additional bandwidth (i.e., higher speed), reduced latency (response time), more redundancy, improved security, etc., or all of these.

The router/firewall 412 in FIG. 4 may also need to be enhanced or increased from what it was when compared to the router/firewall 212 in FIG. 2, to support the addition of the switch 424 in the CATV headend 402. These enhancements or increases could be in the form of additional and/or higher speed ports on the router/firewall 412, faster or more capacity routing, a more secure firewall, etc.

The switch/MUX 410 in FIG. 4 may also need to be enhanced or increased from what it was when compared to the switch/MUX 210 in FIG. 2, to support the addition of the switch 424 in the CATV headend 402. These enhancements or increases could be in the form of additional and/or higher speed ports on the switch/MUX 410, faster or more capacity switching and multiplexing, a more secure switch/MUX 410, etc.

The QAM Mod 406 in FIG. 4 may also need to be enhanced or increased from what it was when compared to the QAM Mod 206 in FIG. 2, to support the addition of the switch 424 in the CATV headend 402. These enhancements or increases could be in the form of additional and/or higher speed ports on QAM Mod 408, faster or higher order modulations, etc.

There may be more CATV modem signals 408 from what there was when compared to the CATV modem signals 208 in FIG. 2, to support the addition of the switch 424 in the CATV headend 402.

Data storage device 419 stores any data relevant to the distributed data center 400, including but not limited to, client data, monitoring, troubleshooting, channel assignment, customer authentication and billing, switch loading and balancing, control, security, energy utilization, and heat generation, etc. While data storage device 419 is not shown as physically connected to any of the other devices in the CATV headend 402, this is only done for graphical convenience, and data storage device 419 is generally connected to the LAN which connects most all the other devices in the CATV headend 402. The data storage device 419 functionality could be provided by one or more physical data storage devices 419, as well as virtually (not shown) within one or more of these physical data storage devices 419, although only 1 such data storage device 419 is illustrated for graphical convenience. Additionally, these data storage devices 419 may also be part of control processor 418 or switch 424, and may be external to the CATV headend 402 for data back-up or disaster recover purposes, etc. (not shown).

The data storage device 419 in FIG. 4 may also need to be enhanced or increased from what it was when compared to the data storage device 219 in FIG. 2, to support the addition of the switch 424 in the CATV headend 402 of the distributed data center 400. These enhancements or increases to data storage device 419 could be in the form of additional memory, faster memory, more back-up memory, more secure memory, remote memory (not shown), etc.

Power supply 420 in FIG. 4 provides powering for the active components of the CATV headend 402. Even though only one power supply 420 is indicated, there could be one or more power supply 420, and these one or more power supply 420 could also include one or more back-up power supplies (not shown) due to the critical nature of providing power to the CATV headend 402. The power connections between the power supply 420 and all these active components in the CATV headend 402 is implied but not indicated, for graphical simplicity. The power supply 420 could also be connected to the LAN of the CATV headend 402 (not indicated) for status monitoring and control of power supply 420.

Likewise, the power supply 420 and any backup power supplies (not shown) in FIG. 4 may also need to be enhanced or increased from what it was when compared to the power supply device 220 in FIG. 2, to support the addition of the switch 424 in the CATV headend 402. These enhancements or increases could be in the form of additional power supplies 420 and/or additional capacity to the existing power supply 420, more back-up power supplies 420 (not shown), etc.

CATV headend 402 in FIG. 4 also includes cooling and ventilation 422, which dissipates any heat generated by any of the above components within the CATV headend 402. Cooling and ventilation 422 could include conventional and non-conventional cooling and ventilation methods. Conventional methods could include HVAC (heating, ventilation and cooling) units, etc., while unconventional methods could include geothermal units, as but just one example of each method. While cooling and ventilation 422 is shown as internal to the CATV headend 402, parts of cooling and ventilation may be external to the CATV headend 402, such the compressors, condenser, fans, etc. (not shown).

Additionally, the cooling and ventilation 422 in FIG. 4 may also need to be enhanced or increased from what it was when compared to the cooling and ventilation 221 in FIG. 2, to support the addition of the switch 424 in the CATV headend 402. These enhancements or increases could be in the form of additional cooling and ventilation 422 and/or additional capacity to the cooling and ventilation 422.

Similarly, the control processor 418 in FIG. 4 may also need to be enhanced or increased from what it was when compared to the control processor 218 in FIG. 2, to support the distributed data center 400, and the addition of the switch 424 in the CATV headend 402. These enhancements or increases could be in the form of additional control processors 418, additional capacity and/or speed to/from and of the control processors 418, more security and/or improved security to the control processors 418, more back-up or remote control processors 418 (not shown), etc.

The user I/O device 417 in FIG. 4 may also need to be enhanced or increased from what it was when compared to the user I/O device 217 in FIG. 2, to support the addition of the switch 424 in the CATV headend 402. These enhancements or increases could be in the form of additional user I/O devices 417, additional capacity and/or speed to/from the user I/O devices 417, more security and/or improved security to the user I/O devices 417, more back-up or remote user I/O devices 417 (not shown), etc.

Similarly, the CMTS 407 in FIG. 4. may also need to be enhanced or increased from what it was when compared to the CMTS 207 in FIG. 2, to support the addition of the switch 424 in the CATV headend 402. These enhancements or increases could be in the form of additional CMTS 407, additional capacity and/or speed to/from the CMTS 407, more security and/or improved security to the CMTS 407, more back-up or remote CMTS 407 (not shown), etc.

One of more of the switch 424, router/firewall 412, switch/MUX 410, data storage device 419, control processor 418, and/or CMTS 407 functionality in FIG. 4. may be provided within and/or external to each of these devices (not shown), potentially even external from the CATV headend 402.

Connections between the switch/MUX 410 and the router/firewall 412, CMTS 407, optical transceiver 404, control processor 418, A/D 415 and D/A 409 are generally although not exclusively over the internal LAN using one or more high speed Ethernet ports (not shown). The LAN is also connected to the data storage device 419 as mentioned, and can also connect to the cooling and ventilation 422 and receiver 414 for status monitoring and control, not shown. Some or all of these connection may need to be enhanced or increased from what to these same connections in FIG. 2, to support the addition of the switch 424 in the CATV headend 402. These enhancements or increases could be in the form of additional connections, additional capacity and/or speed to/from and of these connections, more security and/or improved security to these connections, etc.

Generally, all the remaining functional blocks of CATV headend 402 in FIG. 4 remain the same or similar to those similarly named blocks of the CATV headend 202 in FIG. 2, including the antenna 413, receiver 414, A/D 415, D/A 409, local content 416 and connection 405 in FIG. 4, when compared to the antenna 213, receiver 214, A/D 215, D/A 209, local content 216 and connection 205 in FIG. 2. These similarly named and numbered blocks in FIG. 4 and FIG. 2 provide the same or similar functionality in the CATV headend 402 and CATV headend 202, respectively.

FIG. 4 is also not meant to include all of the particular items in a CATV network 200, only those items that are most relevant to the proposed embodiments of the invention.

FIG. 5 is a block diagram of an alternative CATV node system, according to one embodiment for use as a distributed data center 400, with distributed switches and servers. FIG. 5 is a block diagram of a CATV node system 500, and all the primary components. Within FIG. 5 is one of the CATV nodes 401 from FIG. 4, from which signals are received from and sent to the CATV headend 402, of which some of these signals are distributed to the CATV subscribers served by that particular CATV node 401, and include CATV signals. As indicated in FIG. 4, and as described, there are one or more CATV nodes 401 connected to CATV headend 402, hence there are one or more CATV node systems 500 in the distributed data center. The CATV signals, consisting of CATV content (TV program channels, movies, music, etc.) and high speed data (Internet/WiFi data, VoIP telephony, etc., usually although not necessarily, are generally although not exclusively, transported in the form of DOCSIS, or Data Over Cable Services Interface Specification) signals. From the CATV headend 402, the CATV signals are transported over one or more two-way fiber optic cables 403 to the CATV nodes 401, consisting of an optical transceiver 504 and an RF amplifier 505, which converts the optical CATV signals to CATV RF signals, generally (although not exclusively) from 5 Mhz to 1.8 Ghz, which are then outputted from the CATV node 401 at node outputs 521, and then transported on coaxial cables 507 from the CATV node 401. Even though there is only one node output 521 labelled and shown as coming out of the CATV node 401 in FIG. 5 onto coaxial cables 507, there could be one or more node outputs 521 from one or more RF amp 505 inside CATV node 401.

These CATV signals (both optical and RF) are two-way CATV signals, consisting of both downstream signals and upstream signals. The downstream RF channels are generally (although not exclusively) from 108 Mhz to 1.8 Ghz and consist of the CATV signals going to the home (or businesses) 512 served by the CATV Node 401. The upstream RF channels are generally (although not exclusively) from 5 Mhz to 85 Mhz and consists of the CATV signals coming from the home or business 512 to the CATV node 401.

Also indicated in FIG. 5 is power supply 506, for powering the active devices on a CATV node system 500, which include the CATV node 401 itself, as well as active (powered) device including, but not limited to, the various RF amps 510, servers 517, WiFi access points (not shown), etc., present in the CATV node system 500. While power supply 506 is shown external to the CATV node 401, it could also internal to the CATV node 401, in whole or in part. This power supply 506 injects power (AC or otherwise) from the power grid (not shown), and inserts that power signal to the CATV node system 500, typically, although not exclusively, as 60 Hz AC power from 60 VAC to 90 VAC. This power signal is typically transported on the center conductor of the coaxial cables 507 to or through all the components in the CATV node system 500. The power supply 508 on the right side of FIG. 5 could be similar or different to power supply 506 on the left in FIG. 5, or the power provided could instead be power fed from another output of the CATV node system 500 that has excess power. In either case, the power signal is generally inserted into the CATV node system 500 through a power inserter 509 as indicated, which as before, inserts the power signal onto the center conductor of the coaxial cable 507 of the CATV node system 500. Alternatively, or in addition to, power signal could also be fed directly to one or more RF amps 510 and servers 517 on the CATV node system 500 from a similar or different power supply 506 or power supply 508. Any power supply 506 or power supply 508 on the CATV node system 500 could also include a redundant (back-up) power supply, as well as battery back-up (not shown) to improve the capacity and reliability of the power signal on the CATV node system 500.

Accordingly, the coaxial cables 507 in FIG. 5 transport both the CATV RF signals and the power signal in the CATV node system 500, with one exception. That exception is the coaxial cables 507 connecting the homes (or businesses) 512 to the taps 511, which generally only transport the CATV RF signals to and from the homes 512 (or businesses).

In addition to powering the active devices such as RF amps 510, servers 517, WiFi access points (not shown), etc. on the CATV node system 500, the power signal must pass through passive (non-powered) devices on the CATV node system 500, such as the taps 511 as indicated on FIG. 5. These taps 511 in FIG. 5 allow for both the CATV RF signals and power signal to be passed through them, with the exception noted above, to homes 512 (or businesses), on the center conductor of the coaxial cable 507, for other devices in the CATV node system 500. When the budgeted power for the specified components on the CATV node system 500 has been consumed, an additional power supply 508 and/or power inserter 509 must be added in that leg of the CATV node system 500 requiring power.

The taps 511 in FIG. 5 are in turn connected to one or more homes 512 (and/or businesses, not shown) which split off a portion of the two-way CATV RF signals and sends those two-way CATV RF signals to homes 512 (and/or businesses, not shown), via coaxial cable 507. Each tap 511 services typically between 1 and N homes (or businesses) 512 where N is generally between 1 and 8, and from any given RF amp 510, there would be an M number of taps 511, where M is typically between 4-6 taps 511, until the next RF amp 510 or last home 512 served by the RF amp 510. The number of servers 517 supported by the CATV node system 500 will be described below.

The CATV node 401 in FIG. 5 includes an access layer switch 513, which is connected to optical transceiver 514, via two-way high speed Ethernet or fiber optic cable 516. Included in access layer switch 513 may be one or more high speed Ethernet ports (not shown). The access layer switch 513, similar in functionality to the access layer switch 102 in FIG. 1, is also connected to the CATV headend 402 via fiber optic cables 403, and provide two-way high speed switched data connectivity to the switch 424 at CATV headend 402, which is now an aggregation layer switch as described previously. The access layer switch 513 may also include some or all of the functionality of switch 313 in CATV node 201 from FIG. 3, or the functionality of switch 313 may be separate from the access layer switch 513 (not shown).

Included in or separate from this two-way high speed switched data, the time reference signal generated from the time source 425 in CATV headend 401 is also communicated to the CATV node 401. This time reference signal provides precise synchronization of all the two-way high speed switched data coming into, or going out of, the CATV node 401, and is stored in data storage device 518.

There could also be more than one access layer switch 513 located in the CATV node 401. The optical transceiver 514 converts the two-way high speed output and input electrical data signals from access layer switch 513 to optical data signals, for transport of these data signals over one or more fiber optic cables 515 to one or more servers 517 in FIG. 5. This data could be transported optically from and/or to the optical transceiver 514 to the servers 517 by conventional optical modulation techniques or coherent optical modulation techniques, etc. There could be one or more optical transceivers 514 in any given CATV node 401 or CATV node system 500.

Coordination of all the above functionality, including but not limited, data timing and data decryption/encryption is provided by CPU (central processing unit) 522 in the CATV node 401. CPU 522 is connected to access layer switches 513, optical transceiver 514 and data storage device 518, etc. via high speed connection 516 (Ethernet LAN or otherwise).

Access layer switch 513 is also connected to one or more servers 517 in CATV node system 500. Access layer switch 513 sends two-way high speed switched data of the distributed data center 400 to and receives this two-way high speed switched data from, the one or more servers 517 in CATV node system 500.

CPU 522 and access layer switch 513 control the two-way high speed switched data of the distributed data center 400 to and from the access layer switch 513 and each of the one or more servers 517 in CATV node system 500. Control of this two-way high speed switched data of the distributed data center 400, and specifically to which server 517 this two-way high speed switched data is sent to and received from at any given time, is determined by CPU 522 and access layer switch 513. Control of this data traffic of the distributed data center 400 is determined by many factors, including but not limited to, the type of data, the priority of that data and the specific loading (utilization) of either the access layer switch 513 or any of the servers 517, processing resources available in the servers 517, etc.

CPU 522 and access layer switch 513 also performs the function of load balancing of the two-way high speed switched data of the distributed data center 400, between the access layer switch 513 and all the servers 517 connected to that particular CATV node 401 by fiber optic cables 515, so that the required calculations that need to be performed by the servers 517 in the CATV node system 500 are more efficiently performed and more equally balanced between all the servers 517. This load balancing can be dynamically changed on an as required basis, increasing the efficiency of the data processing within the CATV node system 500, and can also be utilized if one or more of the servers 517 need to be taken off-line as a result of server failure, replacement, upgrade or scheduled maintenance.

CPU 522 and control processor 418 also performs the function of determining the latency (delay) of data signals to and from CATV headend 402 (and aggregation layer switch 424) and the CATV node 401 (and access layer switch 513). This can be accomplished by transmitting a brief data signal to the CATV headend 402 (and aggregation layer switch 424) from the CATV node 401 (and access layer switch 513), in coordination with CPU 522 and control processor 418, and have it returned by the CATV headend 402 (and aggregation layer switch 424) to the CATV node 401, and calculating the latency. The latency is defined as the time delay (difference) between when the brief data signal was transmitted from the CATV node 401 (and access layer switch 513) and when the brief data signal was received back from the CATV headend 402 (and aggregation layer switch 424) at the CATV node 401 (and access layer switch 513), and as calculated by CPU 522 and control processor 418. Calculation of the latency uses the time reference signal generated by from time source 425 and stored in data storage device 419 and data storage device 518 as the common time reference for both the above transmitted and received brief data signal. The latency is a measure of all the inherent time delays to and from the CATV headend 402 (and aggregation layer switch 424) and the CATV node 401 (and access layer switch 513) respectively, and includes not only delays associated with signal transport over the various lengths and types of fiber optic cable 403, but also any signal transport and processing within the CATV headend 402 and CATV node 401. Once the latency is determined, it is stored in data storage device 518 and data storage device 419.

The latency will remain virtually unchanged, unless there are changes to any of the fiber optic cable 403, CATV headend 402 or CATV nodes 401, at which time the above process of determining latency can be recalculated and stored again in data storage device 419 and data storage device 518. The above latency can also be rechecked periodically and recalculated. The above latency calculated will be different between the CATV headend 402 (and aggregation layer switch 424) and each CATV node 401 (and access layer switches 513) on the distributed data center 400, and must be calculated for each CATV node system 500 on the distributed data center 400. These latency calculations will be used to compensate the timing of all future switched data transmissions to and from the CATV headend 402 (and aggregation layer switch 424) and each CATV node 401 (and access layer switch 513) respectively, on the distributed data center 400 to account for these inherent latencies. The latency compensations, in conjunction with the time reference signal described previously from time source 425, will synchronize all such future switched data transmissions to and from the CATV headend 402 (and aggregation layer switch 424) and each CATV node 401 (and access layer switch 513) respectively, on the distributed data center 400. This will allow the future switched data transmissions to and from the CATV headend 402 (and aggregation layer switch 424) and each CATV node 401 (and access layer switch 513) respectively, on the distributed data center 400 to be received by the aggregation layer switch 424 at the CATV headend 402 and the access layer switches 513 at each node 401 at very close to the exact same time. This data synchronization will be performed by a combination of the control processor 418 and aggregation layer switch 424 at the CATV headend 402 and the CPU 522 and access layer switches 513 at each CATV node 401.

The access layer switch 513, optical transceiver 514, CPU 522 or similar means within CATV node 401 and/or the servers 517 and/or the aggregation switch at the CATV headend 402, can support encryption and decryption of these data signals going to and coming from servers 517 and/or CATV headend 402, respectively, for security purposes, using any number of industry encryption techniques (not shown). Some or all of the functionality of the optical transceiver 514 and/or the access layer switch 513 could be located external from the CATV node 401, or even external to the CATV node system 500.

As shown in FIG. 5, there could be one or more optical cables 515 going to and from one or more servers 517 (servers 517 indicated in FIG. 5 as server 1 though server X, where X is one or more) from the optical transceiver 514, even though only one such fiber optic cable 515 is shown connecting to server 517 from the optical transceiver 514, as this was shown only for graphical convenience. Some of these servers 517 (server 1 through server X) may also not be visible in FIG. 5, as they could be downstream (i.e., to the right or the top of the servers 517 that are visible), of those visible servers 517 as noted in FIG. 5 as on coaxial cable 507 going “to other taps, amps and servers”.

Generally, although not exclusively, there is an equal quantity of fiber optic cable 515 and server 517 in any given CATV node system 500. Alternatively, there could be an unequal quantity of fiber optic cables 515 and servers 517 in any given CATV node system 500, if one or more of the outputs of the optical transceiver 514 are on one or more different optical wavelengths on the same or different optical cable 515. Generally, although not exclusively, the number of servers 517 and associated fiber optic cables 515 and/or optical transceivers 514 in any given CATV node system 500 is generally determined by the geographic size and topology of the CATV node system 500, and the number of servers 517 that can be supported by access layer switches 513 in FIG. 5 and aggregation switch 424 in the CATV headend 402.

Some or all of the fiber optical cables 515 necessary to connect the servers 517 to the CATV headend 401 may be already present in the CATV node system 500. The owner and/or operators of the CATV network 200, including the CATV node system 500, will oftentimes install fiber optic cable alongside the coaxial cables 507 for current or future usage, that might function as fiber optic cables 515 in FIG. 5.

FIG. 5 also shows that the servers 517 are connected to the coaxial cables 507. Since the power signal (AC or otherwise) is already present on the coaxial cables 507 as described previously to power the RF amps 510, etc., this same or expanded power present on the coaxial cables 507 can also be used to power the servers 517. Additionally, since the CATV RF (downstream and upstream) is also present on the coaxial cables 507, both the power signal and the CATV RF signal need to be passed through the servers 517 (not shown) to allow for both power signal and the CATV RF signals to be sent to and received from both additional active devices via coax cables 507, such as RF amps 510, servers 517, etc. and passive (non-powered) devices, such as taps 511, etc. which may be downstream (to the right) of the servers 517.

Since the CATV RF signals are also already present on the coaxial cables 507 as described previously, these CATV RF signals could also be used to connect some or all of the servers 517 to the CATV node 401 with two-way high speed switched data connections via a DOCSIS modem (not shown), in addition or supplemental to, the fiber optic cable connections 515 described previously.

CATV node 401 in FIG. 5 also includes data storage device 518. Data storage device 518 provides for data storage relevant to the CATV node 401, including (but not limited to) incoming, interim and outgoing data processed, switch loading and load balancing, decryption and encryption information (such as keys, etc.) for such data, time reference signals, latencies, etc. The data storage device 518 functionality could be provided by one or more physical data storage devices 518, as well as virtually (not shown) within one or more of these physical data storage devices 518, although only 1 such data storage device 518 is illustrated for graphical convenience. These data storage devices 518 would primarily be located within the CATV node 401, although they could also be located remotely from the CATV node 401, in the cloud or otherwise (not shown). Since securing the existence and integrity of the data from the data storage devices 518 is fundamental to the functionality of the CATV node 401, one or more methods of providing redundancy or disaster recovery for such data is provided by the CATV node 401 (not shown). Some or all of the data storage 314 functionality in FIG. 3 may be included in the above mentioned data storage device 518, or it may be separate from the above mentioned data storage device 518.

The power supplies 506 and any backup power (not shown) in FIG. 5 may also need to be enhanced or increased from what it was when compared to the power supply device 306 in FIG. 3, to support the addition of the access layer switch 513 and servers 517 in the CATV node system 500. These enhancements or increases could be in the form of additional power supplies 506 and/or additional capacity to the existing power supply 506, more back-up power supplies 506 (not shown), or alternative powering methods, not shown, etc.

FIG. 5 highlights the CATV node housing 520 surrounding the CATV node 401. The CATV node housing 520 is generally although not exclusively, made out of metal or other materials that efficiently transfer any heat generated from the components of the CATV node 401, such that it can be dissipated into the air around the CATV node housing 520. FIG. 5 also includes cooling fins 519 on the CATV node 401, that help dissipate any of the heat generated internally by the components within the CATV node 401. Even though three such cooling fins 519 are indicated in FIG. 5, there could be more or less than 3 cooling fins 519, and they could each be of the same or different sizes. Cooling fins 519 are generally although not exclusively, made out of metal or other materials, generally attached to, or an integral part of, the CATV node housing 520, such that the any heat generated internally by the components of the CATV node 401 can be more efficiently dissipated into the air around the CATV node housing 520 and cooling fins 519. The cooling fins 519 are generally partially or even fully located around the entire CATV node housing 520. While the CATV housing 520 and cooling fins 519 dissipate any heat generated internally by the components of the CATV node 401, additional cooling methods (not shown) may need to be included in and/or outside CATV node 401, to provide such additional cooling for the addition of switch 513 to the CATV node 401. These methods could include heat pipes, heat sinks, liquid or gas circulation systems, etc. to provide such additional cooling, not shown.

The CATV nodes 401, RF amps 510, taps 511, servers 517, coaxial cables 507 and fiber optic cables 403 and fiber optic cables 515 in FIG. 5 are generally although not exclusively, installed on and supported by, telephone poles and strand wire between those telephone poles (neither shown) in the distributed data center 400, including CATV node system 500. The power supplies 506, power supply 508 and power inserter 509 might also be installed on and supported by, telephone poles and strand wire between those telephone poles (neither shown) in the distributed data center 400, including CATV node system 500.

Even though servers 517 labeled servers 1 through servers X in FIG. 5 have replaced taps 311 labelled taps 2 in FIG. 3, it is not meant to suggest that taps 2 no longer exist in FIG. 5, only that they have been removed for graphical convenience to illustrate the inclusion of servers 517 in FIG. 5. Taps 2 in FIG. 5 are still present, as part of each tap 511 string labelled tap 1 through tap M.

FIG. 5 and the descriptions above are also not meant to include all of the particular items in a CATV node system 500, only those items that are most relevant to the proposed embodiments of the invention.

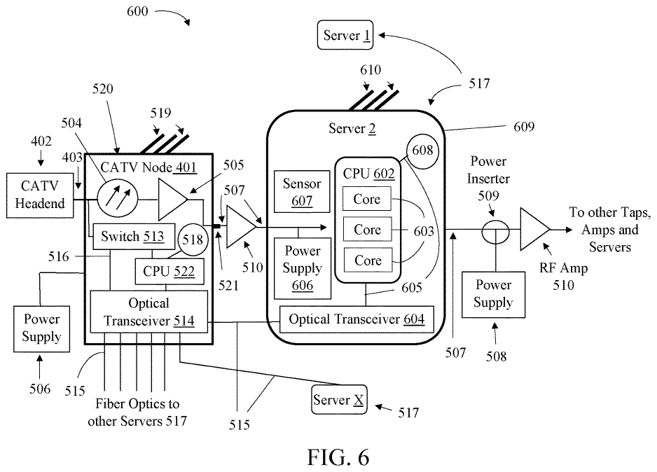

FIG. 6 is a block diagram of an alternative CATV node system 500, according to one embodiment, for use as a distributed data center 400 with distributed servers, with server block diagram. For graphical convenience, only one node output 521 connecting to coaxial cable 507 is indicated in FIG. 6, although there could be more than one node output 521 connecting to coaxial cable 507 coming out of CATV node 401, not shown. All other items and functionality from the CATV node system 500 in FIG. 5 remain present, such as the RF amps 510, taps 511, home 512, etc., even if not indicated in FIG. 6, as well CATV node 401 and the functionality contained within, and described previously in FIG. 5.

FIG. 6 includes the block diagram for server 517 and all the primary components. Server 517 includes a CPU 602 (central processing unit) which includes one or more core processors 603, which are high performance, high efficiency, state of the art computational processing units. The servers 517 are the main processing units in the distributed data center 400, performing complex calculations as required by the distributed data center 400, under the control of CPU 602 and the control processor 418. In addition to performing the above complex calculations as required by the distributed data center 400, CPU 602 can perform data decryption and encryption of the above data coming into, and out of, the server 517, respectively, for security purposes, using any number of industry encryption techniques. CPU 602 also coordinates the timing of the switched data coming into, and out of, the server 517. The time reference signal generated from the time source 425 in CATV headend 402 and communicated to the CATV node system 500 described previously, is also communicated to the servers 517. Even though only 3 such core processors 603 in server 517 are indicated in FIG. 6, there can be one or more core processors 603 as noted above. CPU 602 can be replaced and/or supplemented with GPU (graphics processing unit), not shown, which can use parallel processing to handle multiple tasks simultaneously.

CPU 602 and CPU 522 also performs the function of determining the latency (delay) of data signals to and from the CATV node 401 (and access layer switch 513) and servers 517. This can be accomplished by transmitting a brief data signal to the servers 517 from the CATV node 401 (and access layer switch 513), in coordination with CPU 602 and CPU 522, and have it returned by the server 517 to the CATV node 401 and calculating the latency. The latency is defined as the time delay (difference) between when the brief data signal was transmitted from the CATV node 401 (and access layer switch 513) to the server 517 and when the brief data signal was received back from the server 517 and as calculated by CPU 602 and CPU 522. Calculation of the latency uses the time reference signal generated by from time source 425 and stored in data storage device 419, data storage device 518 and data storage device 608, as the common time reference for both the above transmitted and received brief data signal. The latency is a measure of all the inherent time delays to and from each server 517 from the CATV node 401, and includes not only delays associated with signal transport over the various lengths and types of fiber optic cable 515, but also any signal transport and processing within the servers 517 and CATV node 401. Once the latency is determined, it is stored in data storage device 608 and data storage device 518.

The latency will remain virtually unchanged, unless there are changes to any of the fiber optic cables 515, servers 517, or CATV node 401, at which time the above process of determining latency can be recalculated and stored again in data storage device 608 and data storage device 518. The above latency can also be rechecked periodically and recalculated. The above latency calculated will be different between the CATV node 401 (and access layer switches 513) and each server 517 on the CATV network 500, and must be calculated for each server 517 on the CATV node system 500. These latency calculations will be used to compensate the timing of all future switched data transmissions to and from the CATV node 401 (and access layer switch 513) and each server 517 respectively, on the CATV node system 500 to account for these inherent latencies. The latency compensations, in conjunction with the time reference signal described previously from time source 425 and stored in data storage device 518 and data storage device 608, will synchronize all such future switched data transmissions to and from the CATV node 401 (and access layer switch 513) and each server 517 on the CATV node system 500. This will allow the future switched data transmissions to and from the CATV node 401 (and access layer switch 513) and each server 517 on the CATV node system 500, to be received by the access layer switches 513 at each node 401 and each server 517 at very close to the exact same time. This data synchronization will be performed by a combination of the CPU 522 and access layer switch 513 at CATV node 401 and CPU 602 at each server 517 in the CATV node system 500.

Two-way data communications between each server 517 and the CATV node 401 is accomplished via fiber optic cables 515 which are connected at each end to the optical transceiver 514 at the CATV node 401 and the optical transceiver 604 at the server 517, respectively. The optical transceiver 604 converts the two-way high speed optical data signals from and to the optical transceiver 514 at the CATV node 401, into two-way high speed electrical data signals. The optical transceiver 604 is connected internally at the server 517 via high speed connection 605 (Ethernet LAN or otherwise) to CPU (and/or GPU) 602.

Servers 517 may also contain power supply 606, which receives the power signal transported on the center conductor of the coaxial cables 507, typically, although not exclusively, as 60 Hz AC power from 60 VAC to 90 VAC, and converts that power signal to voltages that might be more readily useable by the components internal to the server 517, such as 12 VDC (volts DC) as but one example, to power the server 517. The power supply 606 might also include back-up power or power storage capabilities, not shown. Even though FIG. 6 indicates only power supply 606 in server 517, there may be one of more power supplies 606 present in server 517, either internal to, or external from, server 517, not shown.

Sensor 607 is included in server 517, to sense any parameters that might be relevant to the server 517, such as temperature, conditions of the power supply 606 and/or any back-up power or power storage capabilities, not shown, conditions and/or interruptions of the data connectivity between the servers 517 and CATV node 401, and/or CATV headend 401, etc.

Servers 517 may also contain memory 608 which can store data relevant to the operation of the server 517. This data stored can include data incoming to and outgoing from the server 517, decryption and encryption information (such as keys, etc.) and time reference signals for this data, latencies, interim data processed by the CPU 602 and/or any of the core processors 603, data from the power supply 606, sensor 607, etc. Even though servers 517 indicates only one memory 608, there may be one of more memory 608 present in server 517, or any memory 608 might also include virtual memory. The memory 608 is connected to the CPU 602 via high speed connection 605 (Ethernet LAN or otherwise).

Alternatively, or in addition to, memory 608 can provide storage for data that may be more general in nature, i.e., not only directly associated with the operation of the server 517 and the above distributed data center 400 and CATV node system 500, but rather as general data being stored by the distributed data center 400 and CATV node system 500 as a service provided to the clients (customers) of the distributed data center 400, CATV node system 500 and CATV node system 700. Such general data could include, but not limited to, back-up personal or business data, including financial records, customer information, legal documentation, databases, patient medical records, multimedia content, emails, etc., to name but a few of the possible types of general data that could be stored in one or more memory 608 in one or more servers 517. This general data could be stored in the above one or more memory 608 on the same distributed data center 400 and CATV node system 500 described. The distributed nature of the distributed data center 400, CATV node system 500 and CATV node system 700 also allows this general data to be individually fragmented by the CATV headend 402, and the fragmented parts stored in and across multiple memories 608 for enhanced security of that general data. The fragmented parts stored in and across multiple memories 608 can then be reassembled by CATV headend 402, when that general data needs to be retrieved.

FIG. 6 also highlights the server housing 609 surrounding the server 517. The server housing 609 is generally although not exclusively, made out of metal or other materials that efficiently transfer any heat generated from the components of the servers 517, such that it can be can be dissipated into the air around the server 517.

FIG. 6 also includes cooling fins 610 on the server 517, that help dissipate any of the heat generated internally by the components within the server 517. Even though three such cooling fins 610 are indicated in FIG. 6, there could be more or less than 3 cooling fins 610, and they could each be of the same or different sizes. Cooling fins 610 are generally although not exclusively, made out of metal or other materials, generally attached to, or an integral part of, the server housing 609, such that any heat generated internally by the components of the server 517 can be more efficiently dissipated into the air around the server housing 609 and cooling fins 610. The cooling fins 610 are generally partially or even fully located around the entire server housing 609. While the server housing 609 and cooling fins 610 dissipate any heat generated internally by the components of the server 610, additional cooling methods (not shown) may need to be included in and/or outside server 517, to provide such additional cooling. These methods could include heat pipes, heat sinks, liquid or gas circulation systems, etc. to provide such additional cooling.

The CATV nodes 401, RF amps 510, taps 511, servers 517, coaxial cables 507 and fiber optic cables 403 and fiber optic cables 515 in FIG. 6 are generally although not exclusively, installed on and supported by, telephone poles and strand wire between those telephone poles (neither shown) in the distributed data center 400, including CATV node system 500. The power supplies 506, power supply 508 and power inserter 509 and any other alternative means of providing and/or storing power in the CATV node system 500, not shown, might also be installed on and supported by, telephone poles and strand wire between those telephone poles (neither shown) in the distributed data center 400, including CATV node system 500.

FIG. 6 and the descriptions above are also not meant to include all of the particular items in a CATV node system 500, only those items that are most relevant to the proposed embodiments of the invention.

FIG. 7 is a block diagram of an alternative CATV node system 700, according to another embodiment, for use as a distributed data center 400, with distributed access switches and distributed servers 517. As in FIG. 6, for graphical convenience, only one node output 521 connecting to coaxial cable 507 is indicated, although there could be more than one node output 521 connecting to coaxial cable 507 coming out of CATV node 401, not shown. All other items from the CATV node system 500 in FIG. 5 remain present, such as the RF amps 510, taps 511, home 512, servers 517, coaxial cables 507, power supply 508 and power inserter 509, etc., even if not indicated in FIG. 7, as well as items connected to coaxial cable 507 going “to other taps, amps and servers”, even if not illustrated in FIG. 7.

FIG. 7 includes one or more access layer switches 701, even though only one such access layer switch 701 is indicated. The access layer switches 701 are each connected to one or more servers 517 via fiber optic cables 706, even though only three such servers 517 and fiber optic cables 706 are indicated. The access layer switches 701 are each also connected to the CATV node 702 via fiber optic cables 705. The servers 517 also remain connected to, and are powered from, the coaxial cables 507 in FIG. 5, even if not illustrated in FIG. 7. One such server 517 (server 2) is shown connected to, and powered from, the coaxial cable 507 in FIG. 7, which then outputs downstream (to the right) of that same server 517 the power and CATV RF signals on coaxial cable 507, to “other taps, amps and servers” as also in FIG. 7.

The CATV node 702 in FIG. 7 includes switch an aggregation layer switch 703, which is connected to optical transceiver 704, via two-way high speed switched data to Ethernet or fiber optic cable 516. Included in aggregation layer switch 703 are one or more high speed Ethernet ports (not shown). The aggregation layer switch 703, is similar in functionality to the aggregation layer switch 103 in FIG. 1, and is also connected to the CATV headend 402 via fiber optic cables 403, and provide two-way high speed switched data connectivity to the switch 424 at CATV headend 402. In the configuration of FIG. 7, the aggregation layer switch 703, is connected to switch 424 at CATV headend 402, which is now a core layer switch 424. Included in this core layer switch 424 at the CATV headend 402 are one or more high speed Ethernet ports (not shown).

Similar to CATV node system 500, there are one or more CATV node systems 700 connected to CATV headend 402 in this distributed data center 400.

Coordination of the above functionality is provided by CPU (central processing unit) 721 in the CATV node 702, in conjunction with control processor 418 at the CATV headend 402. CPU 721 is connected to aggregation layer switches 703, optical transceiver 704 and data storage device 709 via high speed connection (Ethernet LAN or otherwise).

Aggregation layer switch 703 is also connected to one or more access layer switches 701 in CATV node system 700. Aggregation layer switch 703 sends two-way high speed switched data of the distributed data center 400 to and receives from, the one or more access layer switches 701 in CATV node system 700.

CPU 721 and aggregation layer switch 703 control the two-way high speed switched data of the distributed data center 400 to and from the aggregation layer switch 703 and each of the one or more access layer switches 701 in CATV node system 700. Control of this two-way high speed switched data of the distributed data center 400, and specifically to which access layer switch 701 this two-way high speed switched data is sent to and received from at any given time, is determined by CPU 721 and aggregation layer switch 703. Control of this data of the distributed data center 400 is determined by many factors, including but not limited to, the type of data, the priority of that data and the specific loading (utilization) of either the aggregation layer switch 703 and any of the access layer switches 701, processing resources available in the servers 517, etc.

CPU 721 and aggregation layer switch 703 also performs the function of load balancing between the aggregation layer switch 703 and all the access layer switches 701 that are connected to that particular CATV node 702, so that the required switching that need to be performed by the aggregation layer switches 703 in the CATV node system 700 are better performed and more equally balanced between all the access layer switches 701, thereby improving the efficiency of the CATV node system 700. This load balancing can be dynamically changed on an as required basis, increasing the efficiency of the data processing within the CATV node system 700, and can also be utilized if one or more of the access layer switches 701 need to be taken off-line as a result of failure, replacement, upgrade or scheduled maintenance.

CPU 721 and control processor 418 also performs the function of determining the latency (delay) of data signals to and from CATV headend 402 (and core layer switch 424) and the CATV node 401 (and aggregation layer switch 703). This can be accomplished by transmitting a brief data signal to the CATV headend 402 (and core layer switch 424) from the CATV node 401 (and aggregation layer switch 703), in coordination with CPU 721 and control processor 418, and have it returned by the CATV headend 402 (and core layer switch 424) to the CATV node 702, and calculating the latency. The latency is defined as the time delay (difference) between when the brief data signal was transmitted from the CATV node 702 (and aggregation layer switch 703) and when the brief data signal was received back from the CATV headend 402 (and core layer switch 424) at the CATV node 702 (and aggregation layer switch 703), and as calculated by CPU 721 and control processor 418. Calculation of the latency uses the time reference signal generated by from time source 425 and stored in data storage device 419, and transmitted to and stored in data storage device 709, as the common time reference for both the above transmitted and received brief data signal. The latency is a measure of all the inherent time delays to and from the CATV headend 402 (and core layer switch 424) and the CATV node 702 (and aggregation layer switch 703) respectively, and includes not only delays associated with signal transport over various lengths and types of fiber optic cables 403, but also any signal transport and processing within the CATV headend 402 and CATV node 702. Once the latency is determined, it is stored in data storage device 709 and data storage device 419.

The latency will remain virtually unchanged, unless there are changes to any of the fiber optic cables 403, CATV headend 402 or CATV nodes 702, at which time the above process of determining latency can be recalculated and stored again in data storage device 518 and storage device 419. The above latency can also be rechecked periodically and recalculated. The above latency calculated will be different between the CATV headend 402 (and core layer switch 424) and each CATV node 702 (and aggregation layer switches 703) on the distributed data center 400. These latency calculations will be used to compensate the timing of all future switched data transmissions to and from the CATV headend 402 (and aggregation layer switch 424) and each CATV node 702 (and access layer switch 703) respectively, on the distributed data center 400 to account for these inherent latencies. The latency compensations, in conjunction with the time reference signal described previously from time source 425, will synchronize all such future switched data transmissions to and from the CATV headend 402 (and core layer switch 424) and each CATV node 702 (and aggregation layer switch 703) respectively, on the distributed data center 400, and must be calculated for each CATV node 702 and access layer switch 703 on the distributed data center 400. This will allow the future switched data transmissions to and from the CATV headend 402 (and core layer switch 424) and each CATV node 702 (and aggregation layer switch 703) respectively, on the distributed data center 400 to be received by the core layer switch 424 at the CATV headend 402 and the aggregation layer switches 703 at each node 702 to be received at very close to the exact same time. This data synchronization will be performed by a combination of the control processor 418 and core layer switch 424 at the CATV headend 402 and the CPU 721 and aggregation layer switches 703 at each CATV node 702.

There could also be more than one aggregation layer switch 703 located in the CATV node 702, although only one is shown. The aggregation layer switch 703 may also include some or all of the functionality of switch 313 in CATV node 201 from FIG. 3, or the functionality of switch 313 may be separate from the aggregation layer switch 703 (not shown). The optical transceiver 704 converts the two-way high speed output and input electrical data signals from aggregation layer switch 703 to optical data signals, for transport of these data signals over fiber optic cables 705 to access layer switches 701 in FIG. 7. This data could be transported optically from and/or to the optical transceiver 704 to access layer switches 701 by conventional optical modulation techniques or coherent optical modulation techniques. There could be one or more optical transceivers 704 in any given CATV node 702 or CATV node system 700.

The aggregation layer switch 703 and/or optical transceiver 704, CPU 712 or similar means within CATV node 702, the access layer switches 701 and/or the servers 517 and/or the core layer switch 424 at the CATV headend 402, can support encryption and decryption of these data signals going to and coming from the CATV headend 402 to the aggregation layer switches 703 and access layer switches 701 to the servers 517, for security purposes, using any number of industry encryption techniques (not shown). Some or all of the functionality of the optical transceiver 704 and/or the aggregation layer switch 703 could be located external from the CATV node 702, or even external to the CATV node system 700.

As shown in FIG. 7, there could be one or more optical cables 705 going to and from one or more access layer switches 701 from the optical transceiver 704, even though only one such fiber optic cable 705 is shown connecting to access layer switch 701 from the optical transceiver 704, as this was shown only for graphical convenience. Some of these access layer switches 701 and servers 517 may also not be visible in FIG. 7, as they could be downstream (i.e., to the right or the top) of the servers 517 that are visible and connected to coaxial cable 507 going “to other taps, amps and servers”.

Generally, although not exclusively, there is an equal quantity of fiber optic cables 705 and access layer switches 701 in any given CATV node system 700. Alternatively, there could be an unequal quantity of fiber optic cables 705 and access layer switches 701 in any given CATV node system 700, if one or more of the outputs of the optical transceiver 704 are on one or more different optical wavelengths on the same or different optical cable 705. Generally, although not exclusively, the number of access layer switches 701 and associated fiber optic cables 705 and/or optical transceivers 704 in any given CATV node system 700 is determined by the geographic size and topology of the CATV node system 700, and the number of servers 517 that can be supported by the aggregation layer switches 703 and access layer switches 701 in FIG. 7 and switches the core layer switches 424 in FIG. 4.

Some or all of the fiber optical cables 705 and fiber optic cables 706 necessary to connect the access layer switches 701 to servers 517 and to the and CATV node 702 may be already present in the CATV node system 700. The owner and/or operators of the distributed data center 400, including the CATV node system 700, will oftentimes install fiber optic cable alongside the coaxial cables 507 for current or future usage, that might function as fiber optic cables 705 or fiber optic cables 706 in FIG. 7.

Power supply 707 provides powering to the access layer switches 701 and receives that power from the electrical utility power grid or otherwise (not shown). The power supply 707 can be internal to, or external from the access layer switches 701, and can include back-up powering means, from batteries or otherwise (not shown).

Alternatively or in addition to, the access layer switches 701 could be powered directly from coaxial cable 507 in the CATV node system 700, in the same or similar fashion as the servers 517 are powered, and described above, not shown.

Power supply 708 provides powering to the CATV headend 702 and receives that power from the electrical utility power grid or otherwise (not shown). The power supply 708 can also include back-up powering means, from batteries or otherwise (not shown).

CATV node 702 in FIG. 7 also includes data storage device 709. Data storage device 709 provides for data storage relevant to the CATV node 702, including (but not limited to) incoming, interim and outgoing data processed, switch loading and load balancing, decryption and encryption information (such as keys, etc.) for such data, time reference signals, latencies, etc. The data storage device 709 functionality could be provided by one or more physical data storage devices 709, as well as virtually (not shown) within one or more of these physical data storage devices 709, although only 1 such data storage device 709 is illustrated for graphical convenience. These data storage devices 709 would primarily be located within the CATV node 702, although they could also be located remotely from the CATV node 702, in the cloud or otherwise (not shown). Since securing the existence and integrity of the data from the data storage devices 702 is fundamental to the functionality of the CATV node 702, one or more methods of providing redundancy or disaster recovery for such data is provided by the CATV node 702 (not shown). Some or all of the data storage 314 functionality in FIG. 3 may be included in the above mentioned data storage device 709, or it may be separate from the above mentioned data storage device 709.

FIG. 7 highlights the CATV node housing 710 surrounding the CATV node 702. The CATV node housing 710 is generally although not exclusively, made out of metal or other materials that efficiently transfer any heat generated from the components of the CATV node 702, such that it can be dissipated into the air around the CATV node housing 710.

FIG. 7 also includes cooling fins 711 on the CATV node housing 710, that help dissipate any of the heat generated internally by the components within the CATV node 702. Even though three such cooling fins 711 are indicated in FIG. 7, there could be more or less than 3 cooling fins 711, and they could each be of the same or different sizes. Cooling fins 711 are generally although not exclusively, made out of metal or other materials, generally attached to, or an integral part of, the CATV node housing 710, such that the any heat generated internally by the components of the CATV node 702 can be more efficiently dissipated into the air around the CATV node housing 710 and cooling fins 711. The cooling fins 711 are generally partially or even fully located around the entire CATV node housing 710. While the CATV housing 710 and cooling fins 711 dissipate any heat generated internally by the components of the CATV node 702, additional cooling methods (not shown) may need to be included in and/or outside the CATV node 702, to provide such additional cooling. These methods could include heat pipes, heat sinks, liquid or gas circulation systems, etc. to provide such additional cooling.

The CATV nodes 702, RF amps 510, taps 511, servers 517, coaxial cables 507 and fiber optic cables 403, 705 and 706 in FIG. 7 are generally although not exclusively, installed on and supported by, telephone poles and strand wire between those telephone poles (neither shown) in the CATV node system 700. The access layer switches 701, power supplies 506, power supply 508 and power inserter 509 and any other alternative means of providing and/or storing power in the CATV node system 500, not shown, might also be installed on and supported by, telephone poles and strand wire between those telephone poles (neither shown) in the distributed data center 400, including CATV node system 700.

FIG. 7 and the descriptions above are also not meant to include all of the particular items in a CATV node system 700, only those items that are most relevant to the proposed embodiments of the invention.

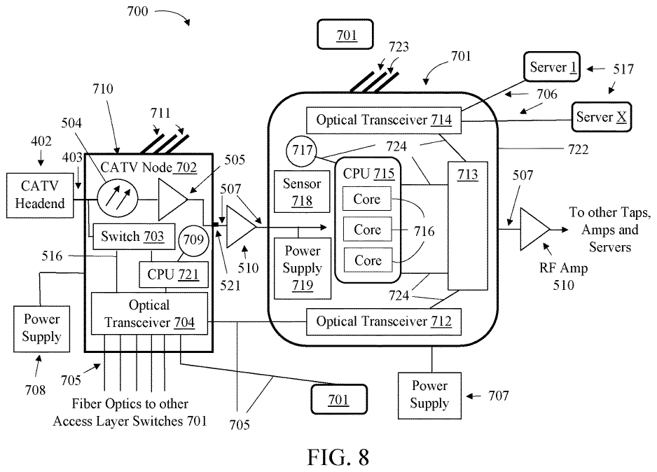

FIG. 8 is a block diagram of an alternative CATV node system 700, according to one embodiment, for use as a distributed data center 400 with distributed access layer switches 701, with access layer switch 701 block diagram. For graphical convenience, only one node output 521 connecting to coaxial cable 507 is indicated, although there could be more than one node output 521 connecting to coaxial cable 507 coming out of CATV node 401, connecting internally to one or more RF amps 505, not shown. All other items from the CATV node system 500 in FIG. 5 remain present, such as the RF amps 510, servers 517, taps 511, home 512, etc., even if not indicated in FIG. 8, as well as items connected to coaxial cable 507 going “to other taps, amps and servers”, even if not illustrated in FIG. 8.

FIG. 8 includes access layer switch block diagram 701 and all the primary components. Access layer switches 701 in FIG. 8 are the same as access layer switches 701 in FIG. 7, only with more access layer switch 710 details provided. Access layer switch 701 includes a CPU 715 (central processing unit) which includes one or more core processors 716, which are high performance, high efficiency, state of the art computational processing units, performing complex calculations for the distributed data center 400, under the control of CPU 715 and aggregation layer switch 703.

The access layer switches 701 in FIG. 8 provide similar functionality as to the access layer switches 102 in FIG. 1. In addition to providing the above data processing, CPU 715 can perform data decryption and encryption of the above data coming into, and out of, the access layer switch 701, respectively, for security purposes, using any number of industry encryption techniques. Even though only 3 such core processors 716 in access layer switch 701 are indicated in FIG. 8, there can be one or more core processors 716 as noted above. CPU 715 can be replaced and/or supplemented with GPU (graphics processing unit), not shown, which can use parallel processing to handle multiple tasks simultaneously.

CPU 715 and CPU 721 also performs the function of determining the latency (delay) of data signals to and from the CATV node 702 (and aggregation layer switch 703) and each access layer switch 701 in the CATV node system 700. This can be accomplished by transmitting a brief data signal to the access layer switches 701 from the CATV node 702 (and aggregation layer switch 703), in coordination with CPU 715 and CPU 721, and have it returned by the access layer switches 701 and calculating the latency. The latency is defined as the time delay (difference) between when the brief data signal was transmitted from the CATV node 702 (and aggregation layer switch 703) and when the brief data signal was received back from each access layer switch 701 at the CATV node system 700, and as calculated by CPU 715 and CPU 721. Calculation of the latency uses the time reference signal generated by from time source 425 and stored in data storage device 419, and also transmitted to and stored in data storage device 709 and data storage device 717, as the common time reference for both the above transmitted and received brief data signal. The latency is a measure of all the inherent time delays to and from each access layer switch 701 and CATV node 702, and includes not only delays associated with signal transport over different lengths and types of fiber optic cable 705, but also any signal transport and processing within each access layer switch 701 and CATV node 702. Once the latency is determined, it is stored in data storage device 709 and data storage device 717.

The latency will remain virtually unchanged, unless there are changes to any of the fiber optic cables 705, access layer switches 701, or CATV node 702, at which time the above process of determining latency can be recalculated and stored again in data storage device 709 and data storage device 717. The above latency can also be rechecked periodically and recalculated. The above latency calculated will be different between the CATV node 702 (and aggregation layer switches 703) and each access layer switch 701 on the CATV network 700, and needs to be calculated for each access layer switch 701. These latency calculations will be used to compensate the timing of all future switched data transmissions to and from the CATV node 702 (and aggregation layer switch 703) and each access layer switch 701, on the CATV node system 700 to account for these inherent latencies. The latency compensations, in conjunction with the time reference signal described previously from time source 425 and stored in data storage device 709 and data storage device 717, will synchronize all such future switched data transmissions to and from the CATV node 702 (and aggregation layer switch 703) and each access layer switch 701 on the CATV node system 700. This will allow the future switched data transmissions to and from the CATV node 702 (and aggregation layer switch 703) and each access layer switch 701 on the CATV node system 700, to be received by the aggregation layer switches 703 at each node 702, and each access layer switch 701, at very close to the exact same time. This data synchronization will be performed by a combination of the CPU 721 and aggregation layer switch 703 at CATV node 702 and CPU 715 at each access layer switch 701 in the CATV node system 700.

Access layer switch 701 is also connected to one or more servers 517 in CATV node system 700. Access layer switch 701 sends two-way high speed switched data of the distributed data center 400 to and receives from, the one or more servers 517 in CATV node system 700.

CPU 715 in access layer switch 701 control the two-way high speed switched data of the distributed data center 400 to and from the access layer switch 701 and each of the one or more servers 517 in CATV node system 700. Control of this two-way high speed switched data of the distributed data center 400, and specifically to which server 517 this two-way high speed switched data is sent to and received from at any given time, is determined by CPU 715 in the access layer switch 703. Control of this data of the distributed data center 400 is determined by many factors, including but not limited to, the type of data, the priority of that data and the specific loading (utilization) of either the access layer switch 701 and any of the servers 517, and/or processing resources available in the servers 517, etc.

CPU 715 in the access layer switch 701 also performs the function of load balancing between the access layer switch 701 and all the servers 517 that are connected to that particular access layer switch 701, so that the required switching that need to be performed by the access layer switches 701 in the CATV node system 700 are better performed and more equally balanced between all the servers 517, thereby improving the efficiency of the CATV node system 700 in the distributed data center 400. This load balancing can be dynamically changed on an as required basis, increasing the efficiency of the data processing within the CATV node system 700, and can also be utilized if one or more of the servers 517 need to be taken off-line as a result of server failure, replacement, upgrade or scheduled maintenance.

CPU 715 and CPU 602 also perform the function of determining the latency (delay) of data signals to and from the access layer switches 701 and servers 517. This can be accomplished by transmitting a brief data signal to each server 517 from the access layer switches 701, in coordination with CU 715 and CPU 602, and have it returned by each server 517 and calculating the latency. The latency is defined as the time delay (difference) between when the brief data signal was transmitted from the access layer switches 701 to each of the servers 517 in CATV node system 700 and when the brief data signal was received back from the server 517 and as calculated by CPU 715 and CPU 602. Calculation of the latency uses the time reference signal generated by from time source 425 and stored in data storage device 419, and transmitted to and stored in data storage device 709, data storage device 717 and data storage device 608, as the common time reference for both the above transmitted and received brief data signal. The latency is a measure of all the inherent time delays to and from each server 517 respectively, and includes not only delays associated with signal transport over the varying lengths and types of each fiber optic cable 706, but also any signal transport and processing within the servers 517 and each access layer switch 701. Once the latency is determined, it is stored in data storage device 608 and data storage device 717.

The latency will remain virtually unchanged, unless there are changes to any of the fiber optic cable 706, servers 517, or access layer switch 701, at which time the above process of determining latency can be recalculated and stored again in data storage device 608 and data storage device 717. The above latency can also be rechecked periodically and recalculated. The above latency calculated will be different between each access layer switch 701 and each server 517 connected to that access switch 701 on the CATV node system 700 and needs to be calculated for each server 517 connected to each access layer switch 701. These latency calculations will be used to compensate the timing of all future switched data transmissions to and from the access layer switch 701 and each server 517 respectively, on the CATV node system 700 to account for these inherent latencies. The latency compensations, in conjunction with the time reference signal described previously from time source 425 and stored in data storage device 608 and storage device 717, will synchronize all such future switched data transmissions to and the access layer switch 701 and each server 517 on the CATV node system 700. This will allow the future switched data transmissions to and from the access layer switch 701 and each server 517 on the CATV node system 700, to be received by the access layer switches 701 and each server 517 connected to that access layer switch 701 at very close to the exact same time. This data synchronization will be performed by a combination of the CPU 715 and access layer switch 701 and CPU 602 at each server 517 in the CATV node system 700.

Two-way data communications between each access layer switch 701 and the CATV node 702 is accomplished via fiber optic cables 705 which are connected at each end to the optical transceiver 704 at the CATV node 702 and the optical transceiver 712 at the access layer switches 701, respectively. The optical transceiver 712 converts the two-way high speed optical data signals from and to the optical transceiver 704 at the CATV node 702, into two-way high speed electrical data signals. The optical transceiver 712 is connected internally at the access layer switch 701 to the Ethernet interface 713 via high speed connections 724 (Ethernet LAN or otherwise) to CPU 715 (and/or GPU).

Access layer switch 701 may also contain power supply 719, which receives the power signal transported on the center conductor of the coaxial cables 507, typically, although not exclusively, as 60 Hz AC power from 60 VAC to 90 VAC, and converts that power signal to voltages that might be more readily useable by the components internal to the access layer switch 701, such as 12 VDC (volts DC) as but one example, to power the access layer switch 701. The power supply 719 might also include back-up power or power storage capabilities, not shown. Even though FIG. 8 indicates only power supply 719 in access layer switch 701, there may be one of more power supplies 719 present in access layer switch 701, not shown. Alternatively or in addition to power supply 719, power could also be provided by power supply 707, which is connected to the electric utility power grid, not shown.

Access layer switches 701 also includes optical transceiver 714, which provides for two-way high speed switched data communications between each access layer switch 701 and each servers 517 connected to that access layer switch 701. This two-way high speed switched data communications is accomplished via fiber optic cables 706 which are connected at each end to optical transceivers 604 at each server 517 and the optical transceiver 714 at the access layer switch 701. The optical transceiver 714 is connected internally at the access layer switch 701 to the Ethernet interface 713 via high speed connections 724 (Ethernet LAN or otherwise) to CPU 715 (and/or GPU). Access layer switch 701 could have one or more optical transceivers 712 and/or optical transceivers 714 connected to one or more optical fiber cables 705 and optical fiber cables 706, respectively. One or more optical fiber cables 705 and/or optical fiber cables 706 could include one or more optical wavelengths on those optical fiber cables 705 and/or optical fiber cables 706.

Sensor 718 is included in access layer switch 701, to sense any parameters that might be relevant to the access layer switch 701, such as temperature, conditions of the power supply 719, power supply 707 and/or any back-up power or power storage capabilities, not shown, conditions and/or interruptions of the data connectivity between the access layer switches 701 and CATV node 702, servers 517 and/or CATV headend 402, etc.

Access layer switches 701 will also contain memory 717 which can store data relevant to the access layer switch 701. This data stored can include data incoming to and outgoing from the access layer switch 701, switch loading and load balancing, decryption and encryption information (such as keys, etc.) and time reference signals for such data, latencies, interim data processed by the CPU 715 and/or any of the core processors 716, data from the power supply 719 and/or power supply 707, sensor 718, etc. Even though access layer switch 701 indicates only one memory 717, there may be one of more memory 717 present in access layer switch 701, or any memory 717 might also include virtual memory, not shown. The memory 717 is connected internally to the CPU 715 in the access layer switch 701 via high speed connections 724 (Ethernet LAN or otherwise).

FIG. 8 also highlights the access layer switch housing 722 surrounding the access layer switch 701. The access layer switch housing 722 is generally although not exclusively, made out of metal or other materials that efficiently transfer any heat generated from the components of the access layer switch 701, such that it can be can be dissipated into the air around the access layer switch 701.

FIG. 8 also includes cooling fins 723 on the access layer switch 701, that help dissipate any of the heat generated internally by the components within the access layer switch 701. Even though three such cooling fins 723 are indicated in FIG. 8, there could be more or less than 3 cooling fins 723, and they could each be of the same or different sizes. Cooling fins 723 are generally although not exclusively, made out of metal or other materials, generally attached to, or an integral part of, the access layer switch housing 722, such that the any heat generated internally by the components of the access layer switch 701 can be more efficiently dissipated into the air around the access layer switch housing 722 and cooling fins 723. The cooling fins 723 are generally partially or even fully located around the entire access layer switch housing 722. While the access layer switch housing 722 and cooling fins 723 dissipate any heat generated internally by the components of the access layer switch 701, additional cooling methods (not shown) may need to be included in and/or outside access layer switch 701, to provide such additional cooling. These methods could include heat pipes, heat sinks, liquid or gas circulation systems, etc. to provide such additional cooling.

The CATV nodes 401, RF amps 510, taps 511, servers 517, coaxial cables 507 and fiber optic cables 515, 705, 706 and 403 in FIG. 8 are generally although not exclusively, installed on and supported by, telephone poles and strand wire between those telephone poles (neither shown) in the distributed data center 400, including CATV node system 700. The access layer switch 701, power supplies 506, power supply 508 and power inserter 509 and any other alternative means of providing and/or storing power in the CATV node system 700, not shown, might also be installed on and supported by, telephone poles and strand wire between those telephone poles (neither shown) in the distributed data center 400, including CATV node system 700.

FIG. 8 and the descriptions above are also not meant to include all of the particular items in a CATV node system 700, only those items that are most relevant to the proposed embodiments of the invention.

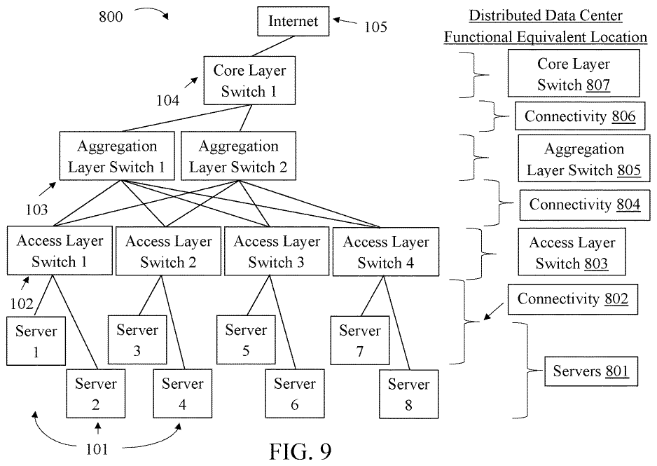

FIG. 9 is a block diagram of an alternative CATV network 800, according to another embodiment, for use as a distributed data center 400, with functional equivalent locations detailed. FIG. 9 includes a portion of FIG. 1 (on the left) of key elements of the centralized data center 100, which compares (on the right), indicating where the functional equivalent locations of those same functional key elements of the centralized data center 100 are now located in the distributed data center 400 contained within CATV node system 700. As noted in FIG. 9, some of the servers 101, access layer switches 102, aggregation layer switches 103, core switches 104 and connections 111 between them have been removed from FIG. 1. This is not to suggest that these removed items no longer exist in the centralized data center 100, it was only done so for graphical convenience, to make room in FIG. 9 for the functional equivalent locations of the key items in FIG. 1, and where those functional equivalent items are now located in the distributed data center 400, contained within CATV node system 700.

Data storage device 106, control processor 107, user input/output device 108, power supply 109 and cooling and ventilation 110 have also been removed from FIG. 1 in FIG. 9, but again, this was only for graphical convenience. The functional location equivalent of data storage device 106, control processor 107, user input/output device 108, power supply 109 and cooling and ventilation 110 in the distributed data center 400 contained within CATV node system 700 will be described in the specification below.

The functional location of servers 801 was detailed as servers 517 in FIG. 7 and FIG. 8, and as described in the specification above.

The functional location of connectivity 802 was detailed as fiber optic cables 706 in FIG. 7 and FIG. 8, and as described in the specification above.

The functional location of access layer switch 802 was detailed as access layer switch 701 in FIG. 7 and FIG. 8, and as described in the specification above.

The functional location of connectivity 804 was detailed as fiber optic cables 705 in FIG. 7 and FIG. 8, and as described in the specification above.

The functional location of aggregation layer switch 805 was detailed as switch 703 in FIG. 7 and FIG. 8, and as described as an aggregation layer switch 703 in the specification above.

The functional location of connectivity 806 was detailed as fiber optic cables 403 in FIG. 7 and FIG. 8, and as described in the specification above.

The functional location of core layer switch 807 was detailed as switch 424 in FIG. 4, and described as a core layer switch 424 in the specification above, for this embodiment.

The functionality of the Internet 105 in FIG. 9, is provided by the Internet 411 in FIG. 4, and as described in the specification above.

The functional location of connectivity 111 in FIG. 1 between the core layer switches 104 and the Internet 105 in FIG. 1, was detailed as fiber optic cables 422 and/or fiber optic cables 423 in FIG. 4, and as described in the specification above.

The functionality of the data storage device 106 in FIG. 1 for the servers 801 in FIG. 9 is provided by the data storage device 608 in FIG. 6, and as described in the specification above.

The functionality of the data storage device 106 in FIG. 1 for the access layer switch 803 in FIG. 9 is provided by the data storage device 717 in FIG. 8, and as described in the specification above.

The functionality of the data storage device 106 in FIG. 1 for the aggregation layer switch 805 in FIG. 9 is provided by the data storage device 709 in FIG. 7 and FIG. 8, and as described in the specification above.

The functionality of the data storage device 106 in FIG. 1 for the core layer switch 807 in FIG. 9 is provided by the data storage device 419 in FIG. 4, and as described in the specification above.

The functionality of the control processor 107 in FIG. 1 for the servers 801 in FIG. 9 is provided by the CPU 602 in FIG. 6, and as described in the specification above.

The functionality of the control processor 107 in FIG. 1 for the access layer switch 803 in FIG. 9 is provided by the CPU 715 in FIG. 7 and FIG. 8, and as described in the specification above.

The functionality of the control processor 107 in FIG. 1 for the aggregation layer switch 805 in FIG. 9 is provided by the CPU 721 in FIG. 7 and FIG. 8, and as described in the specification above.

The functionality of the control processor 107 in FIG. 1 for the core layer switch 807 in FIG. 9 is provided by the control processor 418 in FIG. 4, and as described in the specification above.

The functionality of the user input/output device 108 in FIG. 1 for the servers 801 in FIG. 9 is provided by the user I/O device 417 in FIG. 4, and as described in the specification above.

The functionality of the user input/output device 108 in FIG. 1 for the access layer switch 803 in FIG. 9 is provided by the user I/O device 417 in FIG. 4, and as described in the specification above.

The functionality of the user input/output device 108 in FIG. 1 for the aggregation layer switch 805 in FIG. 9 is provided by the user I/O device 417 in FIG. 4, and as described in the specification above.

The functionality of the user input/output device 108 in FIG. 1 for the core layer switch 807 in FIG. 9 is provided by the user I/O device 417 in FIG. 4, and as described in the specification above.

The functionality of the power supply 109 in FIG. 1 for the servers 801 in FIG. 9 is provided by the power supply 606 in FIG. 6, and as described in the specification above.

The functionality of the power supply 109 in FIG. 1 for the access layer switch 803 in FIG. 9 is provided by the power supply 719 in FIG. 8, and as described in the specification above.

The functionality of the power supply 109 in FIG. 1 for the aggregation layer switch 805 in FIG. 9 is provided by the power supply 708 in FIG. 7 and FIG. 8, and as described in the specification above.

The functionality of the power supply 109 in FIG. 1 for the core layer switch 807 in FIG. 9 is provided by the power supply 420 in FIG. 4, and as described in the specification above.

The functionality of the cooling and ventilation 110 in FIG. 1 for the servers 801 in FIG. 9 is provided by the server housing 609 and server cooling fins 610 in FIG. 6, and as described in the specification above.

The functionality of the cooling and ventilation 110 in FIG. 1 for the access layer switch 803 in FIG. 9 is provided by the access layer switch housing 722 and cooling fins 723 in FIG. 8, and as described in the specification above.

The functionality of the cooling and ventilation 110 in FIG. 1 for the aggregation layer switch 805 in FIG. 9 is provided by the node housing 710 and cooling fins 711 in FIG. 7 and FIG. 8, and as described in the specification above.

The functionality of the cooling and ventilation 110 in FIG. 1 for the core layer switch 807 in FIG. 9 is provided by the cooling and ventilation 422 in FIG. 4, and as described in the specification above.

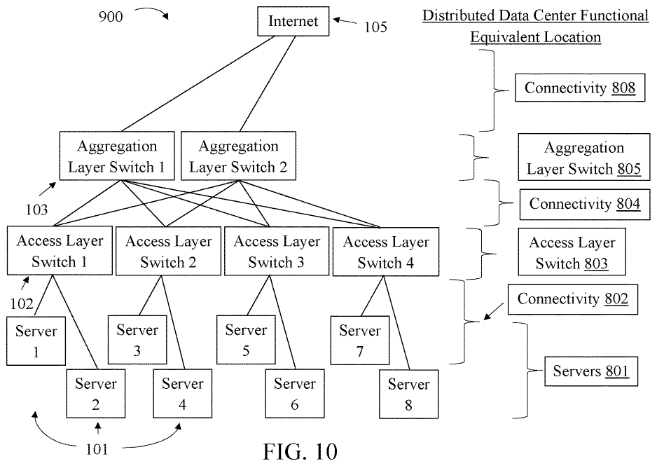

FIG. 10 is a block diagram of an alternative CATV network 900, according to another embodiment, for use as a distributed data center 400, with functional equivalent locations detailed. It can facilitate smaller distributed data centers by removing and/or relocating the core layer switch 805 functionality that was illustrated in FIG. 9. As such, the functionality of the servers 801, connectivity 802, access layer switches 803, connectivity 804, aggregation layer switches 805 and all the other relevant and related components to the servers 801, connectivity 802, access layer switches 803, connectivity 804 and aggregation layer switches 805 described in the specification above, are summarized below, as they relate to the CATV network 900 in FIG. 10

The functional location of servers 801 in FIG. 10 was detailed as servers 517 in FIG. 5 and servers 517 in FIG. 6, and as described in the specification above.

The functional location of connectivity 802 in FIG. 10 was detailed as fiber optic cables 515 in FIG. 5 and FIG. 6, and as described in the specification above.

The functional location of access layer switch 803 in FIG. 10 was detailed as access layer switch 513 in FIG. 5 and FIG. 6, and as described in the specification above.

The functional location of connectivity 804 in FIG. 10 was detailed as fiber optic cables 403 in FIG. 5 and FIG. 6, and as described in the specification above.

The functional location of aggregation layer switch 805 in FIG. 10 was detailed as aggregation layer switch 424 in FIG. 4, and as described as an aggregation layer switch 424 in the specification above, in this embodiment.

The functional location of connectivity 808 in FIG. 10 was detailed as fiber optic cables 422 or fiber optic cables 423 in FIG. 4, and as described in the specification above.

The functional location of core layer switch 807 in FIG. 10 was removed and/or relocated, to allow for smaller distributed data centers in alternative CATV network 900. The core layer switch could optionally be relocated remotely upstream (i.e., above the aggregation layer switches, not shown), to retain the same or similar functionality described in FIG. 9.

The connectivity to the Internet 105 and/or to another WAN network (not shown) in FIG. 10 as connectivity 808 via to fiber optic cables 422 in FIG. 4 and/or via fiber optic cables 423 in FIG. 4, and as described in the specification above.

The functionality of the Internet 105 in FIG. 10, is provided by the Internet 411 in FIG. 4, and as described in the specification above.

The functionality of the data storage device 106 in FIG. 1 for the servers 801 in FIG. 10 is provided by the data storage device 608 in FIG. 6, and as described in the specification above.

The functionality of the data storage device 106 in FIG. 1 for the access layer switch 803 in FIG. 10 is provided by the data storage device 518 in FIG. 5 and FIG. 6, and as described in the specification above.

The functionality of the data storage device 106 in FIG. 1 for the aggregation layer switch 805 in FIG. 10 is provided by the data storage device 419 in FIG. 4, and as described in the specification above.

The functionality of the control processor 107 in FIG. 1 for the servers 801 in FIG. 10 is provided by the CPU 602 in FIG. 6, and as described in the specification above.

The functionality of the control processor 107 in FIG. 1 for the access layer switch 803 in FIG. 10 is provided by the CPU 522 in FIG. 5 and FIG. 6, and as described in the specification above.

The functionality of the control processor 107 in FIG. 1 for the aggregation layer switch 805 in FIG. 10 is provided by the control processor 418 in FIG. 4, and as described in the specification above.

The functionality of the user input/output device 108 in FIG. 1 for the servers 801 in FIG. 10 is provided by the user I/O device 417 in FIG. 4, and as described in the specification above.

The functionality of the user input/output device 108 in FIG. 1 for the access layer switch 803 in FIG. 10 is provided by the user I/O device 417 in FIG. 4, and as described in the specification above.

The functionality of the user input/output device 108 in FIG. 1 for the aggregation layer switch 805 in FIG. 10 is provided by the user I/O device 417 in FIG. 4, and as described in the specification above.

The functionality of the power supply 109 in FIG. 1 for the servers 801 in FIG. 10 is provided by the power supply 606 in FIG. 6, and as described in the specification above.

The functionality of the power supply 109 in FIG. 1 for the access layer switch 803 in FIG. 10 is provided by the power supply 506 in FIG. 5, and FIG. 6, and as described in the specification above.

The functionality of the power supply 109 in FIG. 1 for the aggregation layer switch 805 in FIG. 10 is provided by the power supply 420 in FIG. 4, and as described in the specification above.

The functionality of the cooling and ventilation 110 in FIG. 1 for the servers 801 in FIG. 10 is provided by the server housing 609 and server cooling fins 610 in FIG. 6, and as described in the specification above.

The functionality of the cooling and ventilation 110 in FIG. 1 for the access layer switch 803 in FIG. 10 is provided by the node housing 520 and cooling fins 519 in FIG. 5 and FIG. 6, and as described in the specification above.

The functionality of the cooling and ventilation 110 in FIG. 1 for the aggregation layer switch 805 in FIG. 10 is provided by the cooling and ventilation 422 in FIG. 4, and as described in the specification above.

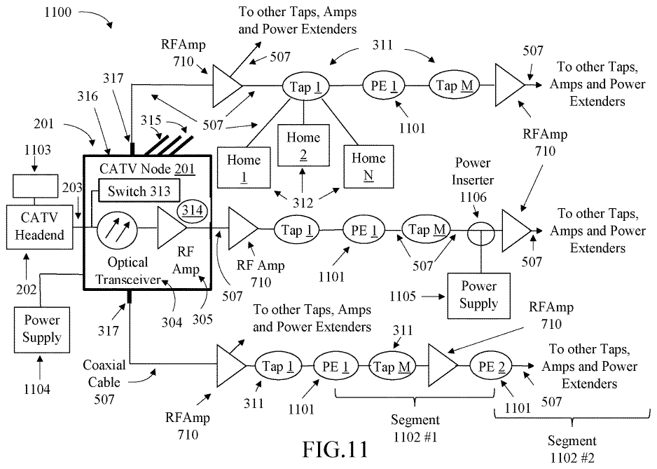

FIG. 11 details another embodiment for a distributed power system 1000. The distributed power system 1000 use power extenders 1101 (PEs) located throughout the CATV node system 1100, to provide for more cost effective, supplemental powering of the active components on a CATV node system 1100, such as RF amps 710, WiFi access points (not shown), etc. Similar to CATV node systems 500 and CATV node systems 700, there are more than one CATV node systems 1100 connected to the CATV headend 402. FIG. 11 also includes RF Amps 710, which provide similar functionality to RF Amps 510 in FIG. 5, FIG. 6, FIG. 7 and FIG. 8, although RF Amps 710 could additionally include the power extender 1101 internally, not shown, but described in more detail later.

There are one or more power extenders 1101 (PEs) located on any given CATV node system 1100. The power extenders 1101 are charged from the power on the CATV node system 1100, primarily, although not exclusively, during off-peak electric utility rate periods, when the electricity rates are lower than during peak electric utility rate periods. Peak and off-peak electric utility rate periods and the price per kilowatt hour for those peak and off-peak electric utility rate periods are established by the local electrical utility provider servicing the CATV node system 1100. One (and only one) such example of a peak electric rate period might be from 4:00 PM to 8:00 PM, local time and one (and only one) such example of an off-peak electric utility rate period might be from 8:00 PM to 4:00, local time. The power extenders 1101 are discharged and provide power to the CATV node system 1100, primarily, although not exclusively, during peak electric utility rate periods, when the electricity rates are higher than during off-peak electric utility rate periods to provide supplemental power to the CATV node system 1100. Power extenders 1101 could also be charged during on-peak electric utility rate periods, as may be required for supplemental power demand, malfunction or maintenance of any active components, expected power outages, etc. on the CATV node system 1100.

Also indicated in FIG. 11 is power supply 1104, for powering the active devices on a CATV node system 1100, which include the CATV node 201 itself, as well as the various amplifiers, power extenders 1101, WiFi access points, (not shown) etc., present in the CATV node system 1100. While power supply 1104 is shown external to the CATV node 201, it could also internal to the CATV node 201, in whole or in part. This power supply 1104 injects power (AC or otherwise) from the power grid of the local electric utility provider (not shown), and inserts that power to the CATV node system 1100, typically, although not exclusively, as 60 Hz AC power from 60 VAC to 90 VAC (volts AC). This power is typically transported on the center conductor of the coaxial cables 507 to or through all the components in the CATV node system 1100. The power supply 1104 on the left of FIG. 11 injects the power directly into the CATV node 201, where the power, in addition to powering CATV node 201, is in turn fed to other components in the CATV node system 1100 via the center conductor of the coaxial cables at node output 317. The power supply 1105 on the right side of FIG. 11 could be similar or different to power supply 1104 on the left in FIG. 11, or it could instead be power provided from another node output 317 of the CATV node system 1100 that has excess power. In either case, the power is generally inserted into the CATV node system 1100 through a power inserter 1106 as indicated, which inserts the power onto the center conductor of coaxial cable 507 of the CATV node system 1100. Alternatively, power could also be fed directly to one or more RF amps 710 from a similar or different power supply 1104 or power supply 1105 on the CATV node system 1100. Any power supply 1104 or power supply 1105 on the CATV node system 1100 could also include a redundant (back-up) power supply to improve the reliability of the power on the CATV node system 1100, not shown.

The CATV RF signals are two-way CATV signals, consisting of both downstream signals and upstream signals as described previously, are also present at node outputs 317 in FIG. 11. The downstream RF channels are generally (although not exclusively) from 108 Mhz to 1.8 Ghz and consist of the CATV signals going to the homes 312 (and/or businesses, not shown) served by the CATV node 201. The upstream RF channels are generally (although not exclusively) from 5 Mhz to 85 Mhz and consists of the CATV signals coming from the home or business 312 to the CATV node 201.

Accordingly, the coaxial cables 507 in FIG. 11 transport both the CATV RF signals and the power signal in the CATV node system 1100, with one exception. That exception is the coaxial cables 507 connecting the homes (or businesses) 312 to the taps 311, which generally only transport the CATV RF signals to the homes (or businesses) 312.

In addition to powering the active devices such as RF amps 710, power extenders 1101, WiFi access points, not shown, etc. on the CATV node system 1100, the power must pass through passive (non-powered) devices on the CATV node system 1100, such as the taps 311 as indicated on FIG. 11. These taps 311 in FIG. 11 allow for both the power and CATV RF signals to be passed through them for other devices in the CATV node system 1100 (with the exception noted above to homes (or businesses) 312). When the budgeted power for the specified active components on the CATV node system 1100 has been consumed, an additional power extender 1101 and/or power supply 1105 and/or power inserter 1106 must be added in that section of the coaxial cable 507 of the CATV node system 1100 requiring power.

The taps 311 in FIG. 11 are in turn connected to homes 312 (and/or businesses, not shown) which split off a portion of the two-way CATV RF signals and presents those two-way CATV signals to homes 312 via coaxial cables 507. Each tap 311 services typically between 1 and N homes 312 where N is generally between 1 and 8, and from any given RF amp 710, there would be a number of M taps 511, where M is typically between 4-6 taps 311 typically until the next RF amp 710 or last home 312 served by the RF amp 710.

The power extenders 1101 (PEs) are located every Y feet apart (ie, the length of segment 1102 #1 in FIG. 11), and provide supplemental powering to the active device such as RF amps 710, WiFi access points (not shown), etc. within that particular segment 1102 in the CATV RF node system 1100, primarily although not exclusively, during peak power electric utility rate periods. The length of segment 1102 #2 in FIG. 11 extends to the bottom right in FIG. 11, until the next power extender 1101, not shown. The length of each segment 1102 in any given CATV node system 1100 can be the same or different than other segments 1102 in any given CATV node system 1100. Although there are two such segments 1102 noted in FIG. 11, there could be more or less than two segments 1102 in any given CATV node system 1100, and these power extenders 1101 (PEs) and segments 1102 can be connected to one of more node outputs 317 from CATV node 201. The number of power extenders 1101 (PEs) and segments 1102 connected to each node outputs 317 from CATV node 201 in FIG. 11 could be the same or different.

Factors effecting the number of power extenders 1101 on any given CATV node system 1100 include the number of active (ie, power consuming) devices on the CATV node system 1101, such as RF Amps 710, CATV nodes 201, WiFi access points (not shown), etc., the frequency of power outages, back-up power redundancy requirements, the number and locations of each power supply 1104, power supply 1105 or power inserter 1105, maintenance schedules and the duration and the pricing of off-peak and on-peak electric utility rates etc. on CATV node system 1100. Power extenders 1101 can be added, removed, or relocated over time as may be required on CATV node system 1100, and can vary individually in power capacity (amp-hours).

CATV node 201 is connected to CATV headend 202 via fiber optic cables 203 as described previously and as illustrated in FIG. 2. As also illustrated in FIG. 2 and described previously, there are more than one CATV node 201 connected to the CATV headend 202, as part of the CATV network 200. Each one or more of these CATV nodes 201 are part of a separate CATV node system 1100 as described above. Each one or more of these CATV nodes 201 that are part CATV network 200 can have the same or different number of power extenders 1101 (PEs) and segments 1102, and they can be connected to one or more node outputs 317 connected to these CATV nodes 201.

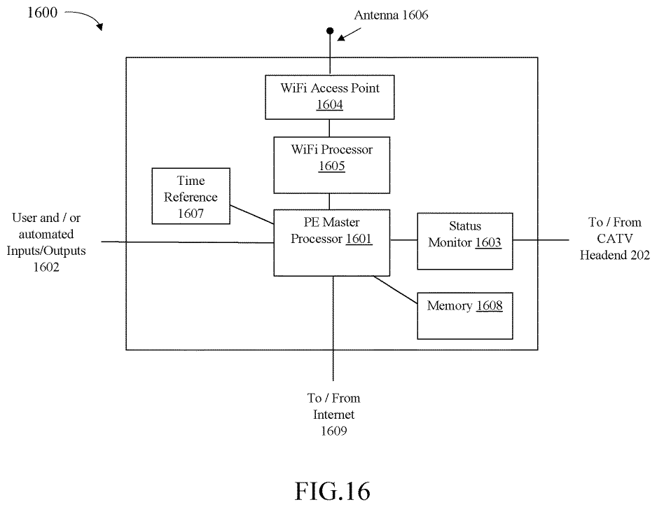

FIG. 11 also includes power extender (PE) master controller 1103 that controls and coordinates each of the above power extender 1101 that are contained within CATV network 200. The power extender master controller 1103 can be connected to CATV headend 202 as indicated in FIG. 11, or the power extender master controller 1103 can be internally part of CATV headend 202, not indicated. Master controller 1103 will be described more fully in FIG. 16 below.

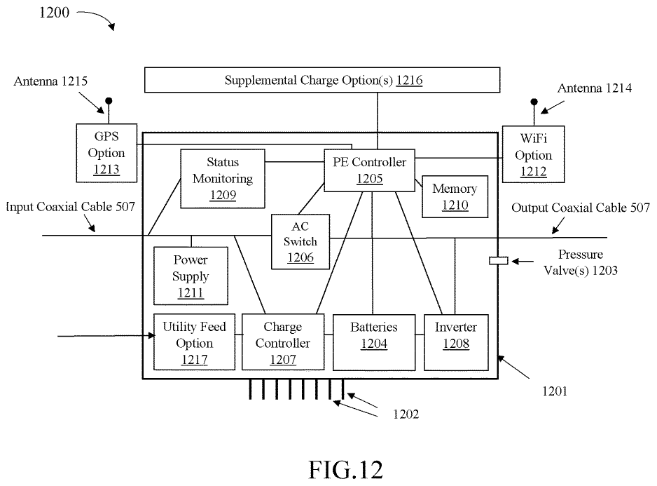

FIG. 12 provides a block diagram 1200 of the power extender 1101, and the main components within, used in the distributed power system 1000 described in FIG. 11.

The power extender 1101 are housed in a housing 1201, metallic or otherwise which provides for internal access via hinges, end caps, etc. (not shown) which may be threaded, hinged or otherwise, (not shown) etc. and could also include cooling fins 1202 as indicated, also made out of metal or otherwise, for dissipating any internal heat generated within power extender 1101. While housing 1201 and cooling fins 1202 dissipate any heat generated internally by the components of the power extender 1101, additional cooling methods (not shown) may need to be included in and/or outside power extender 1101, to provide such additional cooling. These methods could include heat pipes, heat sinks, liquid or gas circulation systems, etc. to provide such additional cooling.

Physical security is provided too such as locking devices, tamperproof screws/bolts, etc. (not-shown) to prevent unauthorized access, tampering, hacking and/or stealing of components within power extender 1101. The housing 1201 would also likely have RF (Radio Frequency) and/or moisture seal(s), not shown, to prevent RF from entering (ingress) or exiting (egress) the housing 1201 and to prevent moisture from entering the housing 1201.

Housing 1201 could also include one or more pressure valves 1203 as so indicated to release internal pressure at a TBD PSI (Pounds per Square Inch) level if needed due to a battery 1204 malfunction or otherwise, within the power extender 1101.

Housing 1201 with the cooling fins 1202 could be optionally designed such they rotate around the center axis of the power extender 1101 to provide the motion to generate electricity within the power extender 1101 during windy periods (not shown).

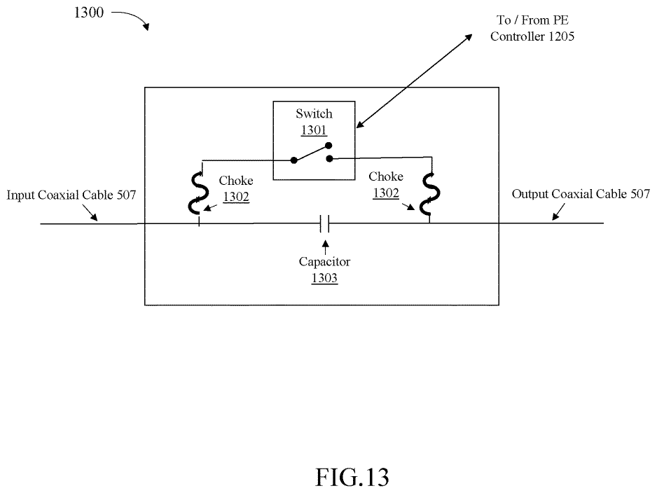

Power extenders 1101 also include the ability to block or pass through the existing power signal on the center conductor of the coaxial cable 507 on the CATV node system 1100 as determined by the PE controller 1205 within the power extender 1101. This functionality is contained within the AC switch 1206 within FIG. 12, detailed later in FIG. 13. In all cases, the CATV RF signal on the center conductor of the input coaxial cable 507 on the CATV node system 1100 is passed through the power extender 1101 to and from the output coaxial cable 507. The CATV RF and power signals (low frequency AC or DC) enter and exit the power extender 1101 via the input coaxial cable 507 and output coaxial cable 507 respectively. The power signal will charge the one or more batter(ies) 1204 within the power extenders 1101 during off-peak electric utility rate periods, primarily.

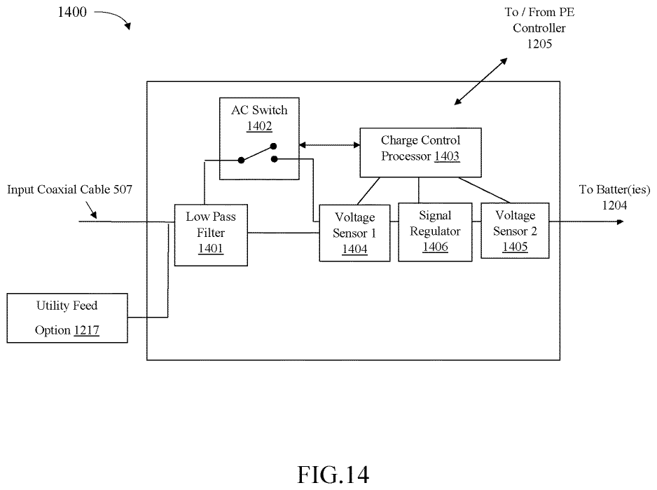

The charge controller 1207 in FIG. 12 is also connected to the input coaxial cable 507 and directs the power signals but not the CATV RF signals, to one or more batter(ies) 1204 for charging the batter(ies) 1204. The CATV RF signals are blocked from entering the charge controller 1207 by means of a low pass filter 1401 (shown later in FIG. 14) in or in front of the charge controller 1207. The charge controller 1207 determines when the batter(ies) 1204 are to be charged, such that they are primarily charged during off-peak electric utility rate periods. This is done via AC switch 1402 within the charge controller 1207 under control from the charge control processor 1403 (See FIG. 14) and/or the PE controller 1205. The charge controller 1207 can also include a rectifier type circuit, to first convert the AC signal power to DC before being sent to the batter(ies) 1204, described in more detail in FIG. 14.

The charge controller 1207 also regulates the duration of the charging of the batter(ies) 1204 so that the batter(ies) 1204 are not under or over charged. One such way the charge controller 1207 can do so is by monitoring the voltages of both the power signal on the input coaxial cable 507 and the DC voltages on the batter(ies) 1204 and controlling the current supplied to the batter(ies) 1204 for charging the batter(ies) 1204. Typically (although not exclusively) the current supplied to the batteries 1204 for charging might initially be higher at the start of charging of the batter(ies) 1204 and then be reduced near the end of charging of the batter(ies) 1204, once the voltage of the batter(ies) 1204 reaches a desired voltage level, as defined by the charge control processor 1403.

The above charging process of batter(ies) 1204 could also be affected by the PE controller 1205 in FIG. 12 as a result of the need and/or timing for more or less power required from the power extender 1101. This could be the result of real time or historical data from the power extender 1101, the CATV RF node 1100 and/or CATV system 200, regarding the power capacity available from the CATV RF node 1100 (including, but not limited to, the power extenders 1101), versus the power capacity needed by the CATV RF node 1100. This data and the power capacity needed by the CATV RF node 1100 can be based on a variety of data, including current, future or historical data, etc. of power consumption by the CATV node 1100, predicted electric utility system power outages from storms, scheduled or unscheduled maintenance, electric utility system brownouts, etc. provided by AI or otherwise. The power extender (PE) master controller 1103 will also be involved in determining the need and/or timing for more or less power required from each power extender 1101 in the CATV system 200, to be detailed later in FIG. 16. As such, the charge controller 1207 can support multiple modes of charging of the batter(ies) 1204, such as rapid charging, normal charging and trickle charging, etc. depending on the above power requirements.

The batter(ies) 1204 within the power extender 1101 are lithium or otherwise, to efficiently store the maximum energy that is provided to them during off-peak (or potentially on-peak) charging hours. They can be connected in a variety of single, series and/or parallel configurations to provide the required voltage and current levels (ie, power) for the CATV node system 1100. The batter(ies) 1204 can be replaceable as a result of failure or scheduled maintenance, or the need for more or less power within the power extender 1101. Upon replacement, repair, troubleshooting or failure of the batter(ies) 1204, the PE controller 1205 is programmed to set the AC switch 1206 to the closed position, to ensure that power is maintained to the CATV node system 1100, regardless of whether such batter(ies) 1204 replacement, repair, troubleshooting or failure occurs during an on-peak or off-peak utility rate period. Once the batter(ies) 1204 have been replaced, the AC switch 1206 is restored to the correct open or closed state by the PE controller 1205, as determined by the off-peak or on-peak cycle present at that specific time when the batter(ies) 1204 have been replaced and/or other considerations as defined by the PE controller 1205 or the power extender (PE) master controller 1103, such as the charge level of the replaced batter(ies) 1204, etc.

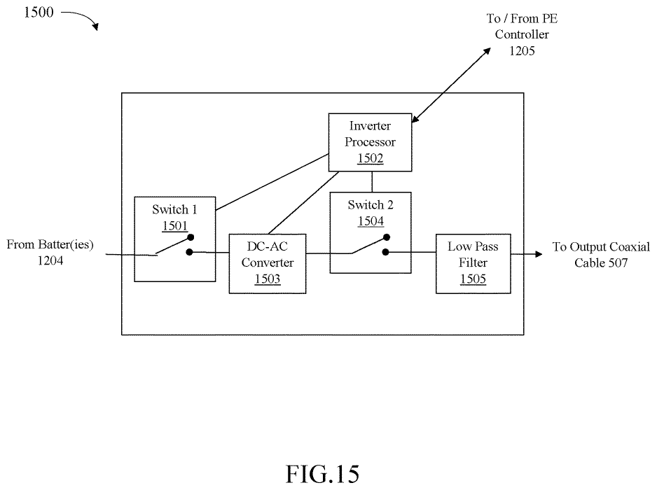

Since batter(ies) 1204 typically store their energy as a DC (Direct Current) voltage, this DC voltage typically needs to be first converted to the same or similar low frequency AC voltage present on the input coaxial cable 507 at the power extender 1101 to be used to power active components on the CATV node system 1100 downstream (i.e., to the segment 1102 to the right of the power extender 1101's). This conversion process is provided by the inverter 1208 detailed in FIG. 15 between the batter(ies) 1204 and the output coaxial cable 507. The inverter 1208 could potentially adjust the frequency, phase and amplitude of this converted low frequency AC power signal, to match the low frequency AC voltage amplitude, frequency and phase present on the input coaxial cable 507 at the power extender 1101. Once inverted, the generated low frequency AC power signal is then outputted to the output coaxial cable 507, for consumption by the active components on the segment 1102 downstream (to the right) of the power extender 1101. This output of the inverter 1208 is also first connected to a low pass filter internal to or external to the inverter 1208 output (not shown), to prevent any RF signals present on the output coaxial cable 507 from entering the inverter 1208, similar to the input of the charge controller 1207 as mentioned previously. More on this in FIG. 15.

The PE controller 1205 mentioned previously in FIG. 12 of the power extender 1101, in addition to interfacing to the charge controller 1207 and affecting the charge controlling process, provides additional functionality within the power extender 1101. The PE controller 1205 as indicated in the power extender 1101 of FIG. 12 is also connected to status monitoring 1209 functionality. Additionally, the PE controller 1205 is connected to the memory 1210 for storage of any programming or data that may be relevant to the PE Controller 1205 and/or the PE master controller 1103 in FIG. 11.

Status monitoring 1209 provides for the status and control of the power extender 1101 at any given instant (and/or prediction based upon historical or other data) in terms of the amount of energy stored and the rate that it is being stored in the batter(ies) 1204 as well as the amount and rate of energy being consumed by the CATV node system 1100 and each segment 1102 between each power extender 1101. Status monitoring 1209 can also detect and record additional information, including the internal and external temperatures present inside and outside the power extender 1101 via temperature sensors at various such locations (not shown). By way of just one such example, status monitoring 1209 could monitor the temperature present on the batter(ies) 1204 and reduce the charging to or disconnect the batter(ies) 1204 and/or the entire power extender 1101 if a temperature exceeding a TBD limit is detected. Similarly, status monitoring 1209 could detect the pressure within the power extender 1101 (not shown).

Status monitoring 1209 can also detect system outages, degradations, or disturbances on the CATV node system 1100 by the lack of RF and/or low frequency AC or DC signals present on the Input or output coaxial cable 507s. Additionally, status monitoring 1209 could monitor and detect the well-being of any of the other components in or around the power extender 1101 in terms of the voltage, current, moisture, etc. or even connectivity of those other components.

Because each power extender 1101 has a unique address (IP, physical, MAC or otherwise, not shown), the above status information is unique, traceable, and controllable to the specific locations of each individual power extender 1101 on the CATV node system 1100. Storage of information relevant to the status monitoring 1209 and the power extender 1101 can also be stored in the memory 1210.

Several types of status monitoring 1209 could be used, depending on a variety of industry standards. Some such standards include SNMP (Simple Network Management Protocol), TR69, HMS (Hybrid Management Sublayer) and/or DOCSIS Data Over Cable Service Interface Specification) and others, generally as specified by SCTE (Society of Cable Telecommunications Engineers) standards. Status monitoring 1209 provides one or two-way communications from each power extender 1101 to a centralized controller (PE master controller 1103, or otherwise) at or connected to the CATV headend 202 or otherwise, using in band or out of band communications via a transponder (not shown). Since the above information communicated from each power extender 1101 to the centralized PE master controller 1103 is unique to each power extender 1101 via its unique address, the above data can be monitored in real time and historical records maintained for troubleshooting, usage, costing, performance improvements, and predictions or otherwise using AI or other means.

Communications between each power extender 1101 and the PE master controller 1103 can be encrypted, to thwart any unauthorized access to the data or control of the power extender 1101 and PE master controller 1103. A wide variety of industry standard encryption techniques are available for the encryption.

Status monitoring 1209 can also provide the means and methods for firmware downloads and/or updates to the power extender 1101, to either correct bugs in the power extender 1101 firmware or add or remove functionality within the power extender 1101. The firmware is generally although not exclusively stored within the memory 1210 illustrated in FIG. 12 and provides the programming for how the PE controller 1205 operates the power extender 1101. This firmware can be updated from the centralized PE master controller 1103 at or connected to, the CATV headend 202 or otherwise as described above or otherwise on an as required basis or automatically whenever the existing firmware revision is out of date.

Additionally, the status monitoring 1209 or the CATV headend 202 can provide a precise “time of day” reference for the power extender 1101, to synchronize many functions within the power extender 1101, specifically although not exclusively, including the AC switch 1206, when the off-peak electric utility power rates go in and out of effect for a more cost-effective charging of the power extender 1101. This timing reference allows all the power extender 1101 on a CATV node system 1100 to coordinate in unison to maximize the savings from off-peak charging of all the power extender 1101 and to minimize any disruptions on the CATV node system 1100. This timing synchronous reference can originate from the PE master controller 1103 at or connected to the CATV headend 202 and communicated to the power extender 1101 via status monitoring 1209. Alternatively, this timing reference could be received and/or updated by the WiFi option 1212 or GPS option 1213 shown in FIG. 12, via their antenna 1214 and antenna 1215, respectively, which either could also provide timing reference signals. Once received, the timing reference is stored and/or updated within the memory 1210 of the power extender 1101. WiFi option 1212 or GPS option 1213 shown in FIG. 12, and their antenna 1214 and antenna 1215, respectively, could be internal to the power extender 1101, external to power extender 1101 in whole or in part.

The memory 1210 in the power extender 1101 is generally non-volatile, meaning all the contents are preserved even in the case of a power failure. This could be facilitated by battery back-up from the batter(ies) 1204 within the power extender 1101 or a separate battery for the memory 1210 (not shown) or by other conventional non-volatile storage techniques.

The power extender 1101 could be additionally charged by supplemental charge option 1216 as indicated in FIG. 12 or solely by other means including photovoltaics thermal gradient generation (TEGs or thermoelectric gradient), or wind (none shown) in, on or around the power extender 1101. The charging of the batter(ies) 1204 from these supplemental charge option 1216 is fed and controlled by the PE controller 1205 as indicated in FIG. 12.

The utility feed option 1217 could also be used to optionally or solely power the power extender 1101, which provides for connectivity with the electric utility power grid, local to the power extender 1101. One or more power extender 1101 could be charged by the utility feed option 1217, including the power extender 1101 illustrated in FIG. 12 and those segment 1102 downstream (ie, to the right) of the power extender 1101 which may not (or may also) have the utility feed option 1217 present in that particular power extender 1101. The utility feed option 1217 could also be added after the initial installation of the power extender 1101(s), in case additional and/or more specific localized power is needed to charge the power extender 1101(s). The utility feed option 1217 could be internal to the power extender 1101 as shown, or external to the power extender 1101 (not shown) and interfaces to the charge controller 1207 to provide supplemental charging of the batter(ies) 1204. The utility feed option 1217 is connected to the local electric utility provider grid, and connects typically at 110 VAC, and converts that electric utility signal to the low frequency AC (or DC) power signal used on the CATV node system 1100. The utility feed option 1217 could also be comprised of a more simplified power inserter (not shown) which inserts the low frequency AC (or DC) power signals directly to the charge controller 1207, without the need to first convert the utility voltage signal to the CATV system low frequency AC (or DC) power signal.

The power extender 1101 once charged (fully or partially) provides the power to the existing active (power consuming) devices such as the RF Amps 710, WiFi access points (not shown), etc. on that particular segment 1102 of the CATV node system 1100 containing that power extender 1101, primarily although not exclusively during on-peak hours. Coordination of the above timing and control of all power extender 1101 is facilitated in conjunction with the PE master controller 1103 located at or connected to, the CATV headend 202, as later described in FIG. 16.

The WiFi option 1212 in FIG. 12 can be both supplemental or alternative to the status monitoring 1209 functionality described previously. This WiFi option 1212 could be enabled if the above described status monitoring 1209 signal is disrupted for any reason, including a CATV node system 1100 outage or maintenance, etc. If conventional Internet access is available via hardwired Ethernet to the power inserter 1101 (not shown) then this Ethernet could also serve as supplemental or alternative status monitoring 1209.

The WiFi option 1212 could also operate as a conventional WiFi access point on the CATV node system 1100, providing WiFi coverage within the prescribed range of the WiFi option 1212. This WiFi coverage could operate independent of the WiFi coverage of other power extender 1101 with a WiFi option 1212, or the WiFi coverage of all the power extender 1101 with the WiFi option 1212 could be linked and coordinated with the other power extender 1101 or even other non-power inserter 1101 based WiFi access points for more seamless and contiguous WiFi coverage. This coordinated mesh WiFi functionality would be provided by a centralized controller somewhere within the CATV node system 1100 (at the PE master controller 1103 or otherwise).

Lastly, FIG. 12 includes power supply 1211, which supplies power to all the necessary active components within the power inserter 1101. The power supply 1211 is generally fed from the low frequency AC (or DC) power signal used on that segment 1102 of the CATV node system 1100 to the left of the power extender 1101 and then converts that signal to useable DC or AC signals for the active components within the power extender 1101, such as 5 or 12 volts DC, as just a few common voltages used. Although individual connections from the power supply 1211 to each of the active components within the power extender 1101 are not indicated they are implied, for graphically convenience.

It should be noted that even though the power extender 1101 in FIG. 12 has only one output coaxial cable 507 illustrated, the power extender 1101 could be provided with more than one output coaxial cable 507 to service additional segment 1102 from that power extender 1101. In this case the architecture of FIG. 12 would similar as described above, except by including additional output coaxial cable 507 outputs connecting those extra outputs internally or externally to the existing output coaxial cable 507 (not shown). In this case, more batter(ies) 1204 might also need to be added to the power extender 1101 to provide additional capacity.

FIG. 13 is a block diagram 1300, highlighting the functionality within the AC switch 1206, which controls flow of the low frequency AC (or DC) power signal used on the CATV node system 1100 from the input coaxial cable 507 to the output coaxial cable 507. This flow is specifically controlled by the switch 1301 as indicated, under control from open or closed signal commands to/from the PE controller 1205. Generally (although not exclusively) this switch will remain closed during off-peak electric utility rate periods and open during on-peak electric utility rate periods. When the switch 1301 is closed, this allows all the other power extender 1101 downstream (ie, to the right) of this particular power extender 1101 to charge their batter(ies) 1204. When the switch 1301 is open, none of the other segments 1102 downstream (ie, to the right) of this particular power extender 1101 can charge their batter(ies) 1204.

It should be noted that this switch 1301 in FIG. 13 is of the normally closed type, meaning that in the absence of a control signal from the PE controller 1205 in the PE, the switch 1301 will remain closed such that the power signal used on the CATV node system 1100 will still flow from the input coaxial cable 507 to the output coaxial cable 507. This keeps the CATV node system 1100 functioning in case there is maintenance or a malfunction within the PE controller 1205 or otherwise within the power extender 1101.

The 2 chokes 1302 as indicated in FIG. 13 function as low pass filters, allowing the (low frequency AC or DC) power signal used on the CATV node system 1100 to be passed and therefore controlled by the switch 1301 but not the RF signals on the CATV node system 1100 described previously, which are blocked by the chokes 1302. Other configurations of low pass filters could be used rather than the simple choke 1302 design as indicated.

The RF signals are allowed to flow from the input coaxial cable 507 to the output coaxial cable 507 continuously through the capacitor 1303 as noted in FIG. 13, which functions as a high pass filter, which passes the RF signals but blocks the (low frequency AC or DC) power signal. Other configurations of high pass filters could be used rather than the simple capacitor 1303 design as indicated. This maintains the RF signal on the CATV node system 1100, regardless of any charging or discharging state of the power extender 1101.

FIG. 14 includes a block diagram 1400, which highlights in more detail the charge controller 1207 described earlier, with the primary functions to control the timing, rate and conditioning of the (low frequency AC or DC) power signal charging the batter(ies) 1204. The input signals feeding the charge controller 1207 include the (low frequency AC or DC) power signal and RF signals from the input coaxial cable 507. Optionally, the charge controller 1207 could also be fed by the utility feed option 1217 described earlier for supplemental (low frequency AC or DC) power signal into the charge controller 1207.

The RF signals on the input coaxial cable 507 are blocked by the low pass filter 1401 as indicated, which allow the (low frequency AC or DC) power signal to be inputted to the AC switch 1402, but not the RF signals. The AC switch 1402 is controlled by the PE controller 1205 via the charge control processor 1403 which controls the timing of the charging of the batter(ies) 1204, primarily during off-peak utility rate periods, by energizing the AC switch 1402 to the closed position, allowing the batter(ies) 1204 to charge. During on-peak utility rate periods, the AC switch 1402 in FIG. 14 as directed by the charge process controller 1402 and/or PE controller 1205 is generally set to the open position. This also prevents the power extender 1101 upstream (to the left) of this power extender 1101 from charging this power extender 1101. The AC switch 1402 is a normally open switch in case there is maintenance or a malfunction within the PE controller 1205, the charge process controller 1402 or otherwise within the power extender 1101.

The output of the AC switch 1402 is fed to voltage sensor 1404, which detects the characteristics of the (low frequency AC or DC) power signal present. These characteristics include the level, frequency, phase and even the presence of the power signal present and are communicated to the charge control processor 1403. Voltage sensor 1404 can also include a connection to the low pass filter 1401 as indicated, so as to be able to measure the same above signal characteristics present on the input coaxial cable 507 in the event the AC switch 1402 is in the open position. By measuring the voltage present on both the input coaxial cable 507 and the output of the AC switch 1402, voltage sensor 1404 can communicate to the charge control processor 1403 whether the AC switch 1402 is in the open or closed position.

As determined from the above signal characteristics, in the event of power degradation, outage or surge of the power on the input coaxial cable 507 and as directed by the charge control processor 1403 and/or PE controller 1205, AC switch 1402 will open to prevent charging of or damage to the batter(ies) 1204 or other components within the power extender 1101. Once this power outage or degradation is no longer present, the charge process controller 1403 and/or PE controller 1205, will close AC switch 1402 to allow the batter(ies) 1204 to charge again, if it is also generally an off-peak electric utility rate period.

This signal characteristic information is transferred to the charge control processor 1403, which is also connected to voltage sensor 1405 which monitors the voltage level of the batter(ies) 1204. Knowing the signal characteristics of the (low frequency AC or DC) power signal present on the input coaxial cable 507 and the voltage present at the batter(ies) 1204, allows the charge control processor 1403 to control the signal regulator 1406 to regulate the charging process of the batter(ies) 1204. As mentioned previously, one such way to regulate the charging process of the batter(ies) 1204 is to control the current into the batter(ies) 1204 during the charging process. The signal regulator 1406 might also need to first rectify (ie, convert the low frequency AC signal to a DC signal) and/or change the level or other characteristics of the charging signal to facilitate the batter(ies) 1204 charging process.

The charge control processor 1403 is connected to the PE controller 1205 as indicated to coordinate the primarily off-peak utility rate charging of all the power extender 1101 on the CATV node system 1100, autonomously and/or in conjunction with the PE master controller 1103 in FIG. 11. The PE master controller 1103 could direct one or more AC switches 1402 or 1301 to open or close during troubleshooting, maintenance, etc. on the CATV node system 1100.

FIG. 15 provides block diagram 1500, which details the inverter 1208 in the power extender 1101. The inverter 1208 is fed from the batter(ies) 1204 which are in turn connected to the switch 1501. Switch 1501, under the control from the inverter processor 1502 determines the precise time to supply the batter(ies) 1204 voltage to the DC-AC converter 1503. This switch 1501 is of the normally open type, so that the batter(ies) 1204 are not accidentally or continuously discharged in case of a malfunction within the inverter 1208 or otherwise.

When directed from the inverter processor 1502, the DC-AC converter 1503 converts the voltage present from the batter(ies) 1204 to the appropriate low frequency AC signal that will power that segment 1102 of the CATV node system 1100 that is downstream (to the right) of the power extender 1101 and all the active devices within that downstream segment 1102. As mentioned in FIG. 3, the inverter 1208 is also connected to the PE controller 1205 and the charge controller 1207, which monitors the input power signal on the input coaxial cable 507. The PE's controller 1205 uses this input power signal information from the charge controller 1207 to allow the DC-AC converter 1503 in the inverter 1208 to match this input power signal information to the power signal output from the inverter 1208, onto output coaxial cable 507.

Optionally, switch 1504 can be included to ensure that any residual power signal on the output of the DC-AC converter 1503 is not presented onto the output coaxial cable 507 when switch 1501 is also open. Likewise, the optional switch 1504 is of the normally open type in case of a malfunction within the inverter 1208 or otherwise.

The output of the DC-AC converter 1503 is then passed through a low pass filter 1505 such that only the power signal is presented to the output coaxial cable 507 from the inverter 1208, and also blocks the RF signals present on the output coaxial cable 507 from entering back into the inverter 1208.

The AC switch 1206 in FIG. 12 and switch 1501 (and optional switch 1504) in FIG. 15 are coordinated by the PE controller 1205, to ensure that power is always maintained on the CATV node system 1100, regardless of the on-peak or off-peak electric utility rate schedules. As such, by one example, if the power extender 1101 is about to enter an on-peak electric utility rate period when CATV node system 1100 power would normally be provided from the batter(ies) 1204, the PE controller 1205 would keep the AC switch 1206 in FIG. 13 engaged (closed), until the power being provided from the output of the inverter 1208 is present, i.e. switch 1501 (and optionally switch 1504) in the inverter 1208 are first engaged (closed). Likewise, if the power extender 1101 is about to enter an off-peak electric utility rate period when CATV node system 1100 power would normally be provided from the existing CATV node system 1100 power, the PE controller 1205 would first ensure that the AC switch 1206 in FIG. 12 is engaged (closed) before switch 1501 (and optionally switch 1504) in the inverter 1208 are disengaged (open).

Additionally, in the event of a power outage, brownout, surge or interruptions, the switch 1501 (and optionally switch 1504) in FIG. 15 could be instructed by the inverter processor 1502 and/or PE controller 1205 to remain closed to provide back-up power to the CATV node system 1100 until the above power outage, brownout, surge, or interruption is corrected, regardless of whether it is an off-peak or on-peak utility rate period.

FIG. 16 highlights a block diagram 1600, of the components within the PE master controller 1103. These components include the PE master processor 1601, which is directed by user and/or automated inputs/outputs 1602 that control the processes of the proposed invention. These processes include many things, including the specific timing and duration of both the charging and discharging of the batter(ies) 1204 within the power extender 1101, as defined by electric utility off-peak and on-peak rate schedules, or as otherwise desired. The PE master processor 1601 also collects data from and sends data to each power extender 1101 via the status monitor 1603 including its transponder (not shown). This data includes performance, troubleshooting and outage data of each power extender 1101, etc., for real time actions and/or historical analysis. Analysis of this data could include AI or otherwise, to allow the PE controller 1103 to predict future system performance based on historical results, such as outages, heavy or light power demands, etc. on the CATV node system 1100.

This data can be transmitted to and received from each power extender 1101 using in-band or out of band RF status monitoring standards as described previously. If this is the case, then the status monitor 1603 is connected to the CATV headend 202 as indicated. Alternatively, this data could be transmitted and received and/or supplemented by the WiFi access point 1604 and WiFi processor 1605 as also indicated in the PE master controller 1103, via antenna 1606, to WiFi option 1212 in FIG. 12.

A time reference 1607 is included in the PE master controller 1103 to allow for the precise and coordinated timing of the charging and discharging of the power extenders 1101 on the CATV node system 1100. This time reference 1607 could be derived from a high precision clock atomic clock, cesium or otherwise or any other precision source, such as a GPS or WiFi signal, or otherwise. Once obtained, the time reference 1607 is also communicated to each power extender 1101 on the CATV node system 1100 to ensure precise synchronization of all the charging and discharging of each power extender 1101.

In addition to helping to facilitate the above alternative WiFi based status monitoring 1209, the WiFi processor 1605 can also coordinate any and all optional WiFi options 1212 that might be included in the power extender 1101 to provide seamless residential and/or business WiFi coverage to the CATV node system 1100.

Contained within the PE master controller 1103 also is memory 1608 which holds the programming and control information for the PE master controller 1103, as well as performance and control data transmitted to and received from the power extender 1101. Time reference 1607 is also stored within memory 1608. Memory 1608 is non-volatile similar to the memory 1210 within the power extender 1101 in FIG. 12.

Lastly, the PE master controller 1103 includes data access to and from the Internet 1609 or other networks via Ethernet or otherwise for a wide variety of purposes, such as dynamic weather or electric utility rate information, off-site data analysis, control and/or predictions with AI or otherwise, etc. Additionally, the connection to the Internet 1609 could also be used as a main or alternative connection for status monitoring 1209 of the power extender 1101, well as providing Internet access to WiFi access point 1604.

While the above description for a distributed power system is specific to an RF CATV node system 1100, the techniques could also be used in an all fiber optic CATV node system 1100 (not shown) to reduce the operating utility costs and outages of the active components of those systems. The segment 1102 of such systems would be similar as in FIG. 11, with a power extender 1101 for each segment 1102. For those segment 1102 of an all fiber optic CATV node system 1100 which do not also transport the (low frequency AC or DC) powering signal, then utility AC power could be implemented as described in FIG. 11 by using the utility feed option 1217, or by other means.

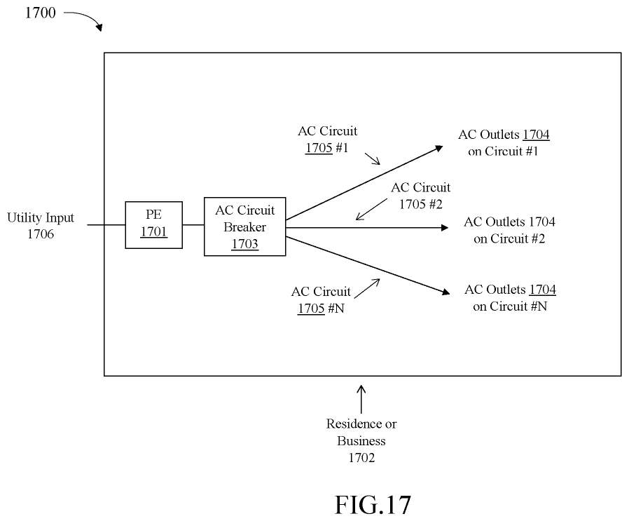

Likewise, the techniques of the proposed invention can also be applied to residential or business electric utility systems to reduce the operating utility costs and outages to, the active components connected to those systems as well, in another embodiment of a distributed power system on an electric utility system. As detailed in the block diagram 1700 in FIG. 17, the power extender 1701 would be placed inside or near the home or business 1702 right before the AC circuit breaker 1703 and all the active components of these systems would be anything plugged into the AC outlets 1704 in the AC circuits 1705 in the home or business 1702. The home or business 1702 would be connected to the electric utility system 1706 as indicated. Power extender 1701 would be similar to power extender 1101, but would not include provisions for CATV RF signals, which are not present on the electric utility grid system 1706. Additionally, powering and charging for the power extender 1701 would be directly from the electric utility system 1706 at their existing 110 VAC rather than the previously used 60-90 VAC power signal used on the CATV node systems 1100. The inverter 1208 used previously in power extender 1101 would also be slightly different in power extender 1701, to convert the voltage of the batter(ies) 1204 to 110 VAC, rather than the previously used 60-90 VAC power signal used on the CATV node systems 1100. The batter(ies) 1204 within these power extender 1701 might have to be of higher capacity, depending upon the powering demands of the home or businesses 1702.

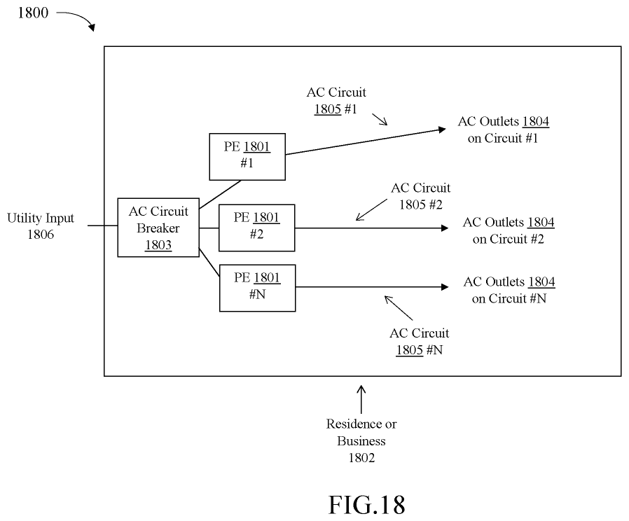

Another embodiment of the proposed invention for home or businesses 1802 is highlighted in the block diagram 1800 in FIG. 18, of a distributed power system on an electric utility system. In this implementation, there is a power extender 1801 included for each AC circuit 1805 after the AC circuit breaker 1803 as illustrated. The home or business 1802 would be connected to the electric utility system 1806 as indicated. Power extender 1801 would be similar to power extender 1101, but would not include provisions for CATV RF signals which are not present on the electric utility grid system 1806. Additionally, powering and charging for the power extender 1801 would be directly from the electric utility system 1806 at their existing 110 VAC rather than the previously used 60-90 VAC power signal used on the CATV node systems 1100. The inverter 1208 used previously in power extender 1101 would also be slightly different in power extender 1801, to convert the voltage of the batter(ies) 1204 to 110 VAC, rather than the previously used 60-90 VAC power signal used on the CATV node systems 1100. The batter(ies) 1204 within these power extender 1801 may be of lower capacity than the batter(ies) 1204 in power extender 1701, depending upon the powering demands of the home or businesses 1802. This would result in lower power capacity power extender 1801 in some or all AC circuits 1805, but more power extender 1801 for any given home or business 1802. This implementation provides for more targeted power within the home or business 1802, and could be partially implemented such that not all of the AC circuits 1805 include a power extender 1801 (not shown).

Given the power extender 1701 and power extenders 1801 include batter(ies) 1204, each of the AC circuits 1705 or AC circuits 1805 that include a power extender 1701 or power extender 1801 in either FIG. 17 or FIG. 18 would also inherently provide battery back-up for those AC circuits 1705 or AC circuits 1805, in the event of an AC power outage to that home or business 1702 or home or business 1802.

Status monitoring 1209 and control of each of the power extender 1701 or power extender 1801 in FIG. 17 and FIG. 18 above, could be via WiFi, Ethernet or even in-band or out of band communications signals which may be available within home or businesses 1802 or home or businesses 1702, or on the electric utility system 1706 or electric utility system 1806 (not shown), to a centrally located controller similar to the PE master controller 1103 in FIG. 16. This is facilitated from each power extender 1701 or power extender 1801 via their PE controller 1205 to such similar PE master controller 1103.

In each of the above alternative implementations the same fundamental principles and savings apply, namely charging the power extender 1101 during off-peak utility rate periods and discharging them during on-peak utility rate periods, as well as reducing service interruptions. Likewise, the alternative implementations would also minimize the overall demand for electricity during on-peak utility rate periods.

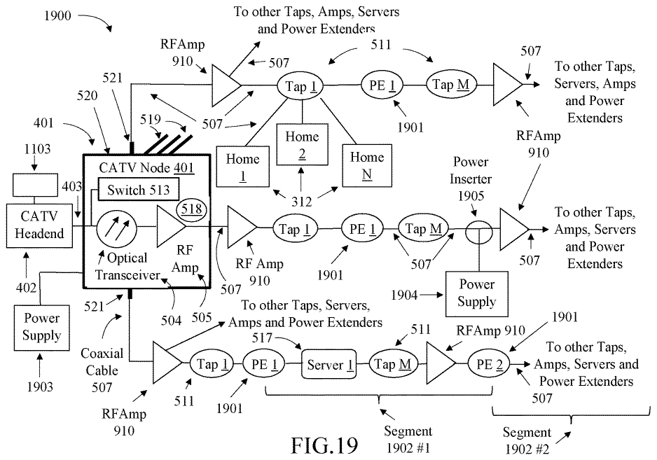

FIG. 19 includes CATV node system 1900, which is another embodiment that includes power extenders 1901 to provide additional power to the active devices in the CATV node system 500 detailed in FIG. 5, including the servers 517 and RF amps 510 in FIG. 5. Similar to CATV node systems 500, CATV node systems 700, and CATV node systems 1100, there are more than one CATV node systems 1900 connected to the CATV headend 402. The power extender 1901 in FIG. 19 is the same or similar to power extender 1101 in FIG. 11, except that the power extender 1901 can provide additional power to the CATV node system 1900, to power the servers 517, fully or partially. As such, power inserter 1901 in FIG. 19 could have additional batter(ies) 1204, additional cooling fins 1202, etc. (not shown), when compared to those same components in the power extender 1101 detailed in FIG. 12, to provide this additional power. RF amp 910 in CATV node system 1900 is the same or similar to RF amp 510 in the CATV node system 500 described in FIG. 5, except that it could also include a power inserter 1101 or power inserter 1901 internal to it, as described previously, not shown.

Segments 1902 in FIG. 19 are similar to segments 1102 in FIG. 11, except the segments 1902 now also include server 517 within segment 1902. Each segment 1902 could include one or more servers 517 within that segment 1902, although potentially there could be no server 517 within any particular segment 1902. The number of power extenders 1901 (PEs) and segments 1902 connected to each node outputs 517 from CATV node 401 in FIG. 19 could be the same or different.

CATV node 401 in FIG. 19 is the same or similar to CATV node 401 in FIG. 5 with the placement and the connections to and from the servers 517 and CATV node 401 the same, even though not all the components shown earlier in CATV node system 500 are indicated in CATV node system 1900, such as fiber optic cables 515, optical transceiver 514, switch 514, CPU 522, etc, as this was done only for graphical convenience. Since switch 514, as described in FIG. 5 and CATV node system 500 is an access layer switch, switch 424 in the CATV headend 402 is an aggregation layer switch.

Accordingly, the CATV node system 1900 provides the benefits of both the distributed data center embodiments 400 in FIG. 5 and FIG. 6, as well as the distributed power system 1000 embodiments in FIG. 11 and FIG. 12, described previously herein.

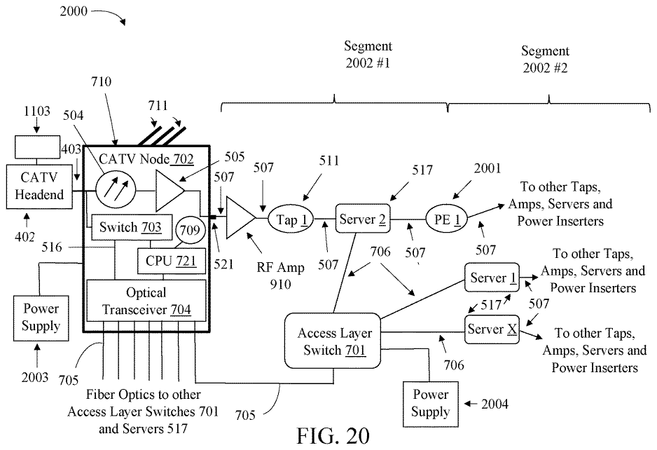

FIG. 20 includes CATV node system 2000, which is another embodiment that includes power extenders 2001 to provide additional power to the active devices in the CATV node system 700 detailed in FIG. 7, including the servers 517, access layer switches 701 and RF amps 510 in FIG. 7. Similar to CATV node systems 500, CATV node systems 700, and CATV node systems 1100, and CATV node systems 1900, there are more than one CATV node systems 2000 connected to the CATV headend 402. The power extender 2001 in FIG. 20 is the same or similar to power extender 1101 in FIG. 11, except that the power extender 2001 can provide additional power to the CATV node system 2000, to also power the servers 517, fully or partially, and access layer switches 701, if so connected as described previously. As such, power inserter 2001 in FIG. 20 could have additional batter(ies) 1204, additional cooling fins 1202, etc. (not shown), when compared to those same components in the power extender 1101 detailed in FIG. 12, to provide this additional power. RF amp 910 in CATV node system 2000 in FIG. 20 is the same or similar to RF amp 510 in the CATV node system 700 described in FIG. 7, except that it could also include a power inserter 1101 or power inserter 2001 internal to it, as described previously, not shown.

Segments 2002 in FIG. 20 are similar to segments 1102 in FIG. 11, except the segments 2002 now also include server 517 (and potentially access layer switch 701, if so connected accordingly) within segment 2002. Each segment 2002 could include one or more servers 517 (and potentially access layer switch 701, if so connected accordingly) in that segment 2002, although potentially there could no server 517 or access switch 701 (if so connected), within any particular segment 2002. The number of power extenders 2001 (PEs) and segments 2002 connected to each node outputs 521 from CATV node 702 in FIG. 20 could be the same or different.

CATV node 702 in FIG. 20 is the same or similar to CATV node 702 in FIG. 7 with the placement and the connections to and from CATV node 702 and the access layer switch 701 the same, and the connections to and from the access layer switch 701 and the servers 517 the same. Since switch 703, as described in FIG. 7 and CATV node system 700 is an aggregation layer switch 703 and switch 424 in the CATV headend 402 is a core layer switch 424, switch 703 in FIG. 20 and CATV node system 2000 is an aggregation layer switch 703.

Accordingly, the CATV node system 2000 provides the benefits of both the distributed data center 400 embodiments in FIG. 7 and FIG. 8, as well as the distributed power system 1000 embodiments in FIG. 11 and FIG. 12, described previously herein.

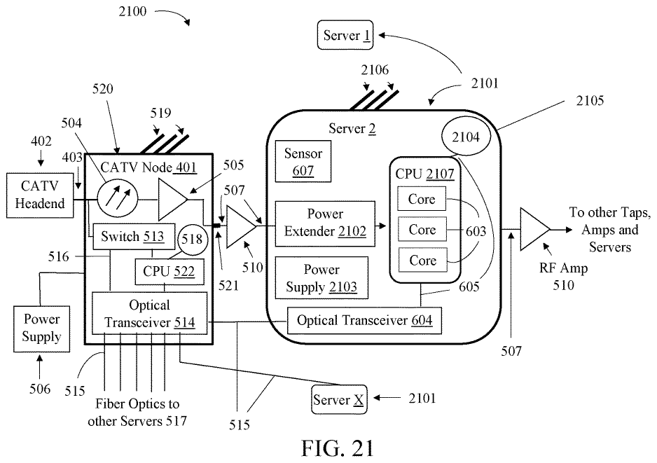

FIG. 21 include CATV node system 2100 which is another embodiment that integrates the power extender 1101 functionality into the server 517 functionality, and detailed as server 2101 in FIG. 21. Similar to CATV node systems 500, CATV node systems 700, and CATV node systems 1100, CATV node systems 1900, and CATV node systems 2000, there are more than one CATV node systems 2100 connected to the CATV headend 402. Power extender 2102 within server 2101 in FIG. 21 provides similar functionality as power extender 1901, but leverages some of that common functionality already provided within server 517, into power extender 2102, resulting in more cost effective power extender 2102, relative to power extender 1101. As such, the CATV node system 2100 will be more cost effective relative to CATV node system 1900 and CATV node system 2000, while providing the same functionality as CATV node system 1900 and CATV node system 2000.

Referring to the server 517 block diagram 500 in FIG. 6 and the block diagram 1200 of the power extender 1101 (PE) in FIG. 12, both the server 517 and power extender 1101 include memory 608 and memory 1210, respectively, that can be combined into memory 2104 of server 2101 in FIG. 21. Similarly, both the server 517 and power extender 1101 include power supply 606 and power supply 1211, respectively, that can be combined into power supply 2103 in FIG. 21. Additionally, both the server 517 and power extender 1101 include CPU 602 and PE controller 1205, respectively, that can be combined into CPU 2107 in FIG. 21. Both the server 517 and power extender 1101 also include server housing 609 and power extender housing 1201, respectively, that can be combined into housing 2105 in FIG. 21. Similarly, both the server 517 and power extender 1101 also include cooling fins 610 and cooling fins 1202, respectively, that can be combined into cooling fins 2106 in FIG. 21. All remaining items in power extender 1101 in FIG. 12 remain in power extender 2102, even if not shown in FIG. 21, providing the same or similar functionality.

While the inventions have been described with respect to specific examples including various modes carry out the inventions, those skilled in the art will appreciate that there are numerous variations and permutations of the above described systems and techniques. It is to be understood that other embodiments may be utilized and structural and functional modifications may be made without departing from the scope of the present inventions. This, the spirit and scope of the inventions should be construed as broadly as set forth in the claims.

What is claimed is:

1. A method comprising:
receiving by a CATV node, high speed switched data signals from a CATV headend;
receiving by a first device at the CATV node, the high speed switched data signals from the CATV headend;
transmitting a portion of the high speed switched data signals from the first device to one or more second devices;
receiving by a second device, a portion of the high speed switched data signals;
transmitting a portion of the high speed switched data signals to one or more third devices;
receiving by a third device, a portion of the high speed switched data signals;
performing the required data calculations by the third device.

2. The method of claim 1, wherein the first device is an aggregation switch.

3. The method of claim 1 wherein the second device is an access layer switch.

4. The method of claim 4, wherein the access layer switch provides load balancing of the high speed switched data signals from the second device to one or more third devices

5. The method of claim 1 wherein the third device is a server.

6. The method of claim 1 wherein the first device, second device and third device are not collocated.

7. A method comprising:
distributing on a CATV node system, one or more first devices,
providing supplemental powering to the CATV node system;
charging during off-peak electric utility rate periods, the first devices;
discharging during peak electric utility rate periods, the first devices.

8. The method of claim 7 wherein the first device is a power extender.

9. The method of claim 8 wherein the charging and discharging of all the power extenders is controlled by a master controller.

10. The method of claim 8 wherein the power extenders provide power to the CATV node system in the event of a power outage on the CATV node system.

11. The method of claim 9 wherein the power extenders can be charged based on predicted power outages on the CATV node system, based on historical data of power outage on the CATV node system stored and analyzed by the master controller.

12. The method of claim 8, wherein a power extender can be disconnected from the CATV node system in the event of a failure of the power extender, so as to not disable the CATV node system.

13. A method comprising:
receiving by a CATV node, high speed switched data signals from a CATV headend;
receiving by a first device at the CATV node, the high speed switched data signals from the CATV headend;
transmitting a portion of the high speed switched data signals from the first device to one or more second devices;
receiving by a second device, a portion of the high speed switched data signals;
transmitting a portion of the high speed switched data signals to one or more third devices;
receiving by a third device, a portion of the high speed switched data signals;
performing the required data calculations by the third device;
distributing on a CATV node system, one or more fourth devices,
providing supplemental powering to the CATV node system;
charging during off-peak electric utility rate periods, the fourth devices;
discharging during peak electric utility rate periods, the fourth devices.

14. The method of claim 13, wherein the first device is an aggregation switch.

15. The method of claim 13 wherein the second device is an access layer switch.

16. The method of claim 13, wherein the access layer switch provides load balancing of the high speed switched data signals from the second device to one or more third devices

17. The method of claim 13 wherein the third device is a server.

18. The method of claim 13 wherein the fourth device is power extender.

19. The method of claim 18 wherein the charging and discharging of all the power extenders is coordinated by a master controller.

20. The method of claim 18 wherein the power extenders is included within the server.
